(19) United States
(12) Patent Application Publication
(10) Pub. No.: US 2024/0196233 A1
(43) Pub. Date: Jun. 13, 2024

(54) METHOD AND DEVICE FOR SELF-CONFIGURATION AND SELF-OPTIMIZATION

(71) Applicant: SAMSUNG ELECTRONICS CO., LTD., Suwon-si, Gyeonggi-do (KR)

(72) Inventors: Xiaoning MA, Beijing (CN); Weiwei WANG, Beijing (CN); Hong WANG, Beijing (CN); Lixiang XU, Beijing (CN); Yi WANG, Beijing (CN); Bin WANG, Beijing (CN); Donmyoung LEE, Beijing (CN)

(21) Appl. No.: 18/556,620

(22) PCT Filed: Apr. 12, 2022
(86) PCT No.: PCT/KR2022/005247

§ 371 Date: Oct. 20, 2023

(30) Foreign Application Priority Data
Apr. 20, 2021 (CN) 202110426970.8

(51) Int. Cl. H04W 24/02; H04L 43/0876; H04W 92/20

(52) U.S. Cl. CPC H04W 24/02; H04L 43/0876; H04W 92/20

(57) ABSTRACT

The disclosure relates to a 5G or 6G communication system for supporting a higher data transmission rate. The present disclosure provides a method and device for self-configuration and self-optimization. There is disclosed a method performed by a first node in a wireless communication network, comprising: receiving, by the first node, a first message related to information on an unlicensed spectrum from a second node; performing, by the first node, self-optimization according to the information on the unlicensed spectrum.

### TECHNICAL FIELD

The present application relates to wireless communication technology, and in particular to a method and device for self-configuration and self-optimization.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In order to meet an increasing demand for wireless data communication services since a deployment of 4G communication system, efforts have been made to develop an improved 5G or pre-5G communication system. Therefore, the 5G or pre-5G communication system is also called “beyond 4G network” or “post LTE system”

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

With continuous growth of wireless communication services, the shortage of licensed spectrum resources has gradually become one of the problems to be solved in wireless communication networks. To solve this problem, 5G mobile communication network began to consider deployment in an unlicensed spectrum. In this way, the 3GPP communication protocol is used to provide services in the unlicensed spectrum as a supplement and extension of licensed spectrum services.

Because the unlicensed spectrum has the characteristics of sharing without any permission, it competes with other communication technologies, such as WLAN, that also use this spectrum. In order to achieve a fair coexistence with other technologies, LBT (Listen Before Talk) mechanism is supported, that is, before communication, the channel occupancy ratio/percentage is monitored, and the channel can only be used if a condition is met. When the requested channel is occupied for a long time, the nodes that need to communicate cannot send data, resulting in a LBT failure.

### DISCLOSURE OF INVENTION

### Technical Problem

In NR, due to the characteristics of NR-U (NR unlicensed), it is necessary to obtain information related to an unlicensed spectrum to avoid a problem of a wireless communication failure.

### Solution to Problem

According to an aspect of the present disclosure, there is provided a method performed by a first node in a wireless communication network, comprising: receiving, by the first node, a first message related to information on a licensed spectrum and/or an unlicensed spectrum from a second node; performing, by the first node, self-optimization according to the information on the licensed spectrum and/or the unlicensed spectrum.

According to an embodiment of the present disclosure, the first message comprises configuration information of a channel, and wherein the configuration information of the channel comprises at least one of the following information: a channel ID, a center frequency, a bandwidth, a starting frequency, an ending frequency, a flag indicating whether the channel is used for an initial random access, an energy detection threshold, a maximum energy detection threshold, an energy detection threshold offset, or a flag indicating whether there is another access technology that uses the same spectrum resource.

According to an embodiment of the present disclosure, the first message comprises indication information related to the unlicensed spectrum, and the indication information comprises at least information on one or more cells of which configuration needs to be changed, for the second node.

According to an embodiment of the present disclosure, the method further comprises: sending a second message to the second node based on the first message, wherein the second message comprises at least one of the following information: information on one or more cells of which configuration is successful, information on one or more cells of which configuration is failed, or configuration information of a channel used for the initial random access.

According to an embodiment of the present disclosure, the first node sends a second message comprising request information to the second node, and the request information requests the second node to report the first message comprising load information of the licensed spectrum and/or the unlicensed spectrum of one or more cells, wherein the request information comprises at least one of the following information: a cell identity, configuration information of load information of a channel used by one or more beams, configuration information of load information of one or more slices, configuration information of load information of a channel used by one or more Public Land Mobile Networks (PLMNs), configuration information of load information of a channel used by one or more Non-Public Networks (NPNs), or configuration information of load information of a channel.

According to an embodiment of the present disclosure, the first message comprises at least one of the following information: a cell identity, load information of a channel used by one or more beams, load information of one or more slices, load information of a channel used by one or more Public Land Mobile Networks (PLMNs), load information of a channel used by one or more Non-Public Network (NPN, or load information of a channel, wherein the load information of the channel comprises at least one of the following information: at least one piece of information of configuration information of a channel, a Received Signal Strength Indicator (RSSI), a Channel Occupancy ratio/percentage (CO), a number of Listen Before Talk (LBT) failures, a success ratio (percentage) or a failure ratio (percentage) of the LBT, an average sending duration after a successful LBT, a transmit power, a maximum transmit power, a flag indicating whether to enable uplink and downlink shared channel occupation, a number of time slots used for the uplink and downlink shared channel occupation, a position of time slots used for the uplink and downlink shared channel occupation, an energy detection ED threshold used for the uplink and downlink shared channel occupation, a channel access priority used for the uplink and downlink shared channel occupation, a number of consecutive LBT failures, a detection duration used to detect consecutive LBT failures, a maximum number for detecting consecutive LBT failures, or a proportion of available or unavailable physical resources to all physical resources.

According to an embodiment of the present disclosure, the first message comprises at least one set of Physical Random Access Channel (PRACH) configuration parameters used by at least one cell, and the first message further comprises: information for indicating PRACH configuration parameters currently used for the initial random access.

According to an embodiment of the present disclosure, the method further comprises: receiving a report related to wireless connection of an unlicensed spectrum from a third node, wherein the report related to the wireless connection comprises at least one of the following information: a center frequency of a spectrum used for random access, a Received Signal Strength Indicator (RSSI) in the random access, a Channel Occupancy ratio/percentage (CO) in the random access, a flag indicating whether there is another access technology that uses the same spectrum resource, a channel access priority, a center frequency of a spectrum used for connection with a source access node, a RSSI for the connection with the source access node, a CO for the connection with the source access node, a flag, configured by the source access node, indicating whether there is another access technology that uses the same spectrum resource, a channel access priority for the connection with the source access node, a center frequency of a spectrum used for connection with a target access node, a RSSI for the connection with the target access node, a CO for the connection with the target access node, a flag, configured by the target access node, indicating whether there is another access technology that uses the same spectrum resource, or a channel access priority for the connection with the target access node.

According to an embodiment of the present disclosure, the method further comprises: sending a second message comprising Minimum Drive Test (MDT) configuration information of a channel to the second node, wherein the MDT configuration information comprises at least one of the following information: a category flag indicating MDT measurement for the unlicensed spectrum, a flag indicating the MDT measurement for the unlicensed spectrum on the UE side, MDT measurement related information for the unlicensed spectrum on the UE side, a flag indicating the MDT measurement for the unlicensed spectrum on the access node side, or MDT measurement related information for the unlicensed spectrum on the access node side, wherein the MDT measurement related information comprises at least one of the following information: a flag indicating whether it is a timing report or an event-triggered report, a time interval of the timing report, a length of time of the timing report, a flag of a event that triggers reporting, a threshold of a RSSI that triggers reporting, a duration that the RSSI exceeds the threshold; a threshold of RSSI that stops reporting, a hysteresis parameter of the RSSI that triggers or stops reporting, a threshold of a Channel Occupancy ratio/percentage (CO) that triggers reporting, a duration that the CO exceeds the threshold, a threshold of the CO that stops reporting, a hysteresis parameter of the CO that triggers or stops reporting, a flag indicating whether there is another access technology that uses the same spectrum resource, or a channel access priority.

According to an embodiment of the present disclosure, the first message comprising the MDT measurement report is generated based on the MDT configuration information, and wherein the MDT measurement report comprises at least one of the following information: a center frequency of the measured spectrum, a bandwidth of the measured spectrum, a Received Signal Strength Indicator (RSSI), a Channel Occupancy ratio/percentage (CO), a flag indicating whether there is another access technology that uses the same spectrum resource, a channel access priority, a flag indicating that this measurement occurs on the UE side, or a flag indicating that this measurement occurs on the access node side.

According to an embodiment of the present disclosure, the first message comprises a measurement report message of the unlicensed spectrum, wherein the measurement report message comprises at least one of the following information: a center frequency of a spectrum used for random access, a Received Signal Strength Indicator (RSSI) in the random access, a Channel Occupancy ratio/percentage (CO) in the random access, a flag indicating whether there is another access technology that uses the same spectrum resource, a channel access priority, a center frequency of a spectrum used for connection with a source access node, a RSSI for the connection with the source access node, a CO for the connection with the source access node, a flag, configured by the source access node, indicating whether there is another access technology that uses the same spectrum resource, a channel access priority for the connection with the source access node, a center frequency of a spectrum used for connection with a target access node, a RSSI for the connection with the target access node, a CO for the connection with the target access node, a flag, configured by the target access node, indicating whether there is another access technology that uses the same spectrum resource, or a channel access priority for the connection with the target access node.

According to an embodiment of the present disclosure, the measurement report message is included in container information included in an inter-node interface message, or is included outside the container information included in the inter-node interface message.

According to an embodiment of the present disclosure, an interface between the first node and the second node is an Xn interface, or an X2 interface, or an F1 interface, or an Ng interface, or an S1 interface, or an interface between two gNB-DUs.

According to an embodiment of the present disclosure, the first node and the second node are different gNBs or different eNBs, or different units of an access node, or an access node and a core network node.

According to another aspect of the present disclosure, there is provided a method performed by a first node in a wireless communication network, comprising: sending, by the first node, a handover request message to a second node; and receiving, by the first node, a response message to the handover request message from the second node, wherein the response message comprises at least one of the following information: a flag indicating whether forwarding data in advance can be accepted; a maximum acceptable amount of data forwarded in advance that needs to be cached.

According to an embodiment of the present disclosure, the method further comprises: sending a message comprising information related to the unlicensed spectrum to a third node, wherein the information related to the unlicensed spectrum comprises at least one of the following information: at least one piece of information of configuration information of a channel, a Received Signal Strength Indicator (RSSI) measured by a cell on the channel, a Channel Occupancy ratio/percentage (CO) measured by the cell on the channel, a threshold of the RSSI, or a threshold of the CO.

According to an embodiment of the present disclosure, an interface between the first node and the second node is an Xn interface or an X2 interface, wherein the first node and the second node are different gNBs or different eNBs.

According to another aspect of the present disclosure, there is provided a method performed by a second node in a wireless communication network, comprising: sending, by the second node, a first message related to information on an unlicensed spectrum to a first node, so that the first node performs self-optimization according to the information on the unlicensed spectrum.

According to another aspect of the present disclosure, there is provided a method performed by a second node in a wireless communication network, comprising: receiving, by the second node, a handover request message from a first node; and sending, by the second node, a response message to the handover request message to the first node, wherein the response message comprises at least one of the following information: a flag indicating whether forwarding data in advance is acceptable, a maximum acceptable amount of the data forwarded in advance that needs to be cached.

According to another aspect of the present disclosure, there is provided a first node in a wireless communication network, comprising: a transceiver, configured to receive and send signals; and a controller, coupled with the transceiver and configured to control to perform the method as described by the embodiment of the present disclosure.

According to another aspect of the present disclosure, there is provided a second node in a wireless communication network, comprising: a transceiver, configured to receive and send signals; and a controller, coupled with the transceiver and configured to control to perform the method as described by the embodiment of the present disclosure.

### Advantageous Effects of Invention

The present disclosure proposes a method for self-configuration and self-optimization. With this method, in the scenario of deploying the unlicensed spectrum, information related to the unlicensed spectrum can be obtained for performing self-configuration and self-optimization, so as to avoid the problem of communication failure and improve the user experience.

### BRIEF DESCRIPTION OF DRAWINGS

FIG. 1 is a system architecture diagram of system architecture evolution (SAE);

FIG. 2 is a schematic diagram of the initial overall architecture of 5G;

FIG. 3 is a schematic diagram of embodiment 1 according to an embodiment of the present disclosure;

FIG. 4 is a schematic diagram of embodiment 2 according to an embodiment of the present disclosure;

FIG. 5 is a schematic diagram of embodiment 3 according to an embodiment of the present disclosure;

FIG. 6 is a schematic diagram of embodiment 4 according to an embodiment of the present disclosure;

FIG. 7 is a schematic diagram of embodiment 5 according to an embodiment of the present disclosure;

FIG. 8a and FIG. 8b are a schematic diagram of embodiment 6 according to an embodiment of the present disclosure;

FIG. 9 is a schematic diagram of embodiment 7 according to an embodiment of the present disclosure;

FIG. 10 is a schematic diagram of embodiment 8 according to an embodiment of the present disclosure;

FIG. 11 is a schematic diagram of embodiment 9 according to an embodiment of the present disclosure;

FIG. 12 is a schematic diagram of embodiment 10 according to an embodiment of the present disclosure;

FIG. 13 is a schematic diagram of embodiment 11 according to an embodiment of the present disclosure; and

FIG. 14 is a block diagram of a network node device according to an embodiment of the present disclosure.

### MODE FOR THE INVENTION

In this text, an access node can configure one or more channels on the unlicensed spectrum used, and these are used to provide services on the unlicensed spectrum. Different access nodes can configure different channels. For example, a base station can be configured with an unlicensed spectrum with an appropriate frequency band, and the unlicensed spectrum can be configured as any number of channels, and each channel can be configured as the same or different bandwidths.

In this text, a RSSI (Received Signal Strength Indicator), unless otherwise specified, refers to a RSSI used for the unlicensed spectrum, which will not be repeated in the following.

Due to the characteristics of a NR-U, a LBT failure may cause some wireless communication problems. Currently, there is no overall technical solution for discovering these problems, identifying the causes of these problems, and better optimization to avoid continuous occurrence of these problems.

The present disclosure proposes a method for self-configuration and self-optimization. With this method, in the deployment scenario of an unlicensed spectrum, information on the wireless communication problems can be reported to the relevant base station, the cause of these problems can be identified, and reasonable self-optimization can be performed, so as to avoid the continuous occurrence of these problems and improve the user experience.

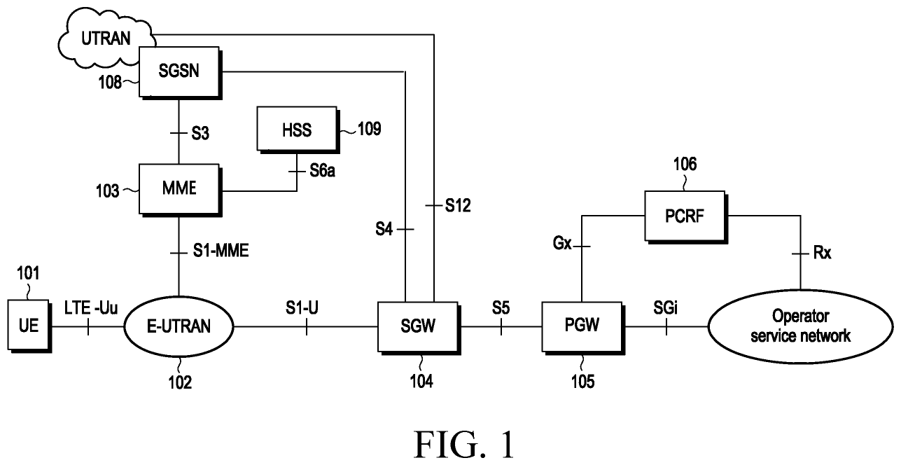

FIGS. 1 to 14 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A serving gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QoS) policies and charging criteria. A general packet radio service support node (SGSN) 108 is a network node device that provides routing for data transmission in a universal mobile telecommunications system (UMTS). A home subscriber server (HSS) 109 is a home subsystem of the UE, and is responsible for protecting user information including a current location of the user equipment, an address of a serving node, user security information, and packet data context of the user equipment, etc.

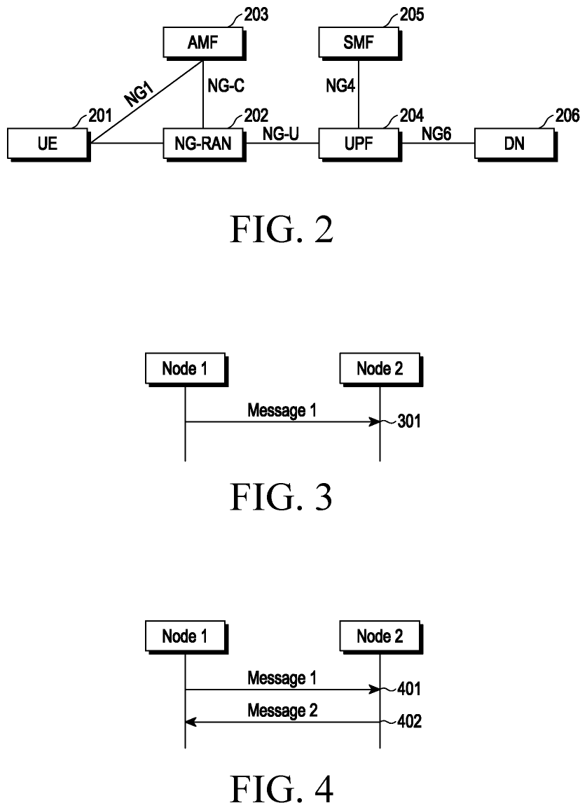

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to 5G core network 5GC, and the eNB connected to the 5GC is also called ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity SMF 205 is responsible for session management. A data network (DN) 206 includes, for example, services of operators, access of Internet and service of third parties.

### Problem 1:

At present, in a scenario where adjacent access nodes or distributed units deploy an unlicensed spectrum, different access nodes or distributed units do not know each other's channel information. In some scenarios, such as load balancing or UE mobility scenarios, it is necessary to consider channel states of candidate target cells. If adjacent access nodes or distributed units do not know each other's channel information and cannot make the optimal choice, for example, the selected target cell is not optimal, which may cause network problems, such as a wireless connection failure, thus affecting the user experience.

A method for self-configuring and self-optimizing includes the following steps.

Node 1 can send channel information of one or more cells to Node 2 through an inter-node interface message. The channel information may include configuration information of one or more channels. The configuration information of the channel includes, but is not limited to, at least one of the following information:
A channel ID;
A center frequency;
A bandwidth;
A starting frequency;
An ending frequency;
A flag indicating whether the channel is used for an initial random access;
An ED threshold (Energy Detection threshold);
A maximum ED threshold (Maximum energy detection threshold);
An ED threshold offset (energyDetectionThresholdOffset, indicating an offset from the default value of the maximum ED threshold);
A flag indicating whether there is another access technology that uses the same spectrum resource (absenceOfAnyOtherTechnology).

The ED threshold, and/or the maximum ED threshold, and/or the ED threshold offset, and/or the flag indicating whether there is another access technology that uses the same spectrum resource can also be separate configuration information for all or part of the channels.

The frequency-related parameters and bandwidth are used to identify a channel. The ED threshold related parameters are used to generate the measurement results of the channel, such as the RSSI or the CO. The flag indicating whether the channel is used for the initial random access is used to avoid using the same channel for the initial random access between adjacent nodes, thereby reducing a possibility of the initial random access failure, such as the initial random access failure caused by lbt failure.

Node 1 and Node 2 may be different access nodes, such as different gNBs or different eNBs, may be different units belonging to an access node, such as gNB-DU and gNB-CU, may be an access node and a core network node, such as gNB and AMF, or eNB and MME, may be an secondary node and a master node in a dual-connectivity or multi-connectivity scenario, or may be different units belonging to one or more access nodes, such as different gNB-DUs.

The inter-node interface can be an Xn interface, an X2 interface, an F1 interface, an Ng interface or an S1 interface. The inter-node interface may also be an interface between two gNB-DUs.

When the inter-node interface is an Xn interface, the inter-node interface message includes, but is not limited to, at least one of the following messages: XN SETUP REQUEST, XN SETUP RESPONSE, NG-RAN NODE CONFIGURATION UPDATE, NG-RAN NODE CONFIGURATION UPDATE ACKNOWLEDGE, CELL ACTIVATION REQUEST, CELL ACTIVATION RESPONSE, RESET REQUEST, RESET RESPONSE, S-NODE ADDITION REQUEST, S-NODE ADDITION REQUEST ACKNOWLEDGE, S-NODE MODIFICATION REQUEST, S-NODE MODIFICATION REQUEST ACKNOWLEDGE, S-NODE MODIFICATION REQUIRED, S-NODE MODIFICATION CONFIRM, S-NODE CHANGE REQUIRED, S-NODE CHANGE CONFIRM, and a newly defined XN message.

When the inter-node interface is an X2 interface, the inter-node interface message includes, but is not limited to, at least one of the following messages: X2 SETUP REQUEST, X2 SETUP RESPONSE, RESET REQUEST, RESET RESPONSE, ENB CONFIGURATION UPDATE, ENB CONFIGURATION UPDATE ACKNOWLEDGE, CELL ACTIVATION REQUEST, CELL ACTIVATION RESPONSE, EN-D X2 SETUP REQUEST, EN-DC X2 SETUP RESPONSE, EN-DC CONFIGURATION UPDATE, EN-DC CONFIGURATION UPDATE ACKNOWLEDGE, EN-DC CELL ACTIVATION REQUEST, EN-DC CELL ACTIVATION RESPONSE, EN-DC CONFIGURATION TRANSFER, SGNB ADDITION REQUEST, SGNB ADDITION REQUEST ACKNOWLEDGE, SGNB MODIFICATION REQUEST, SGNB MODIFICATION REQUEST ACKNOWLEDGE, SGNB MODIFICATION REQUIRED, SGNB MODIFICATION CONFIRM, SGNB CHANGE REQUIRED, SGNB CHANGE CONFIRM, SENB ADDITION REQUEST, SENB ADDITION REQUEST ACKNOWLEDGE, SENB MODIFICATION REQUEST, SENB MODIFICATION REQUEST ACKNOWLEDGE, SENB MODIFICATION REQUIRED, SENB MODIFICATION CONFIRM, and a newly defined X2 message.

When the inter-node interface is an F1 interface, the inter-node interface message includes, but is not limited to, at least one of the following messages: F1 SETUP REQUEST, F1 SETUP RESPONSE, RESET, RESET ACKNOWLEDGE, GNB-DU CONFIGURATION UPDATE, GNB-DU CONFIGURATION UPDATE ACKNOWLEDGE, GNB-CU CONFIGURATION UPDATE, GNB-CU CONFIGURATION UPDATE ACKNOWLEDGE, and a newly defined F1 message.

When the inter-node interface is an Ng interface, the inter-node interface message includes, but is not limited to, at least one of the following messages: NG SETUP REQUEST, NG SETUP RESPONSE, RAN CONFIGURATION UPDATE, RAN CONFIGURATION UPDATE ACKNOWLEDGE, AMF CONFIGURATION UPDATE, AMF CONFIGURATION UPDATE ACKNOWLEDGE, NG RESET, NG RESET ACKNOWLEDGE, UPLINK RAN CONFIGURATION TRANSFER, DOWNLINK RAN CONFIGURATION TRANSFER, and a newly defined Ng message.

When the inter-node interface is an S1 interface, the inter-node interface message includes, but is not limited to, at least one of the following messages: S1 SETUP REQUEST, S1 SETUP RESPONSE, RESET, RESET ACKNOWLEDGE, ENB CONFIGURATION UPDATE, ENB CONFIGURATION UPDATE ACKNOWLEDGE, MME CONFIGURATION UPDATE, MME CONFIGURATION UPDATE ACKNOWLEDGE, eNB DIRECT INFORMATION TRANSFER, MME DIRECT INFORMATION TRANSFER, eNB CONFIGURATION TRANSFER, MME CONFIGURATION TRANSFER, and a newly defined S1 message.

When the inter-node interface is an interface between two gNB-DUs, the inter-node interface message may include, for example, but is not limited to, at least one of the following messages: a message related to setting or resetting the interface, and a message related to node configuration update.

After Node 2 receives the configuration information of the channel from Node 1, the node can use the information for self-configuration or self-optimization, such as the load balancing or the initial random access optimization. After self-configuration or self-optimization, the access node avoids the problem of load imbalance in the network or reduces the possibility of the initial random access failure, improves the network performance and enhances the user experience.

### Problem 2:

For different nodes, such as a central unit and a distributed unit, or different gNBs or eNBs, or a master node and a secondary node in a dual-connectivity or multi-connectivity scenario, or different distributed units, the node can decide by itself to configure different parameters for each channel, such as a transmit power, an ED threshold, etc. However, in some scenarios, such as a central unit and a distributed unit, the central unit manages and configures different distributed units in a unified way, which can avoid poor configuration parameters among different distributed units, thus eliminating the resulting problems, such as a LBT failure.

Another method for self-configuration and self-optimization includes the following steps.

Node 1 can send indication information to Node 2 through an inter-node interface message, and the indication information includes, but is not limited to, at least one of the following information:

Information on one or more cells of which configuration needs to be changed.

The information on the cell of which configuration needs to be changed includes, but is not limited to, at least one of the following information:
A cell identity;
Information on one or more channels of which configuration needs to be changed;
A flag indicating that the channel used for the initial random access needs to be changed.

The cell identity may be a Cell Global ID (CGI) and/or an NR Physical Cell ID (PCI). The CGI can be a NR CGI or an E-UTRA CGI.

The information on the channel of which configuration needs to be changed includes, but is not limited to, at least one of the following information:
At least one piece of information of the configuration information of the channel, such as a channel ID;
A flag indicating whether the channel is used for the initial random access;
A transmit power;
A maximum transmit power;
A flag indicating whether to enable uplink and downlink shared channel occupation (COT sharing);
A number of time slots used for the uplink and downlink shared channel occupation;
A position of time slots used for the uplink and downlink shared channel occupation;
An ED threshold used for the uplink and downlink shared channel occupation;
A channel access priority used for the uplink and downlink shared channel occupation;
A detection duration used to detect consecutive LBT failures;
A maximum number for detecting consecutive LBT failures.

The flag indicating that the channel used for the initial random access needs to be changed can be used to inform Node 2 to change the channel used for the initial random access. Node 2 can select an appropriate channel as a new channel used for the initial random access by itself.

Node 2 can send a response message to Node 1. The response message includes, but is not limited to, at least one of the following information:
Information on one or more cells of which configuration is successful;
Information on one or more cells of which configuration is failed;
At least one piece of information of the configuration information of the channel used for the initial random access, for example, including, but being not limited to, at least one of a channel ID, a center frequency point and a bandwidth.

The information on the cell of which configuration is successful includes, but is not limited to, at least one of the following information:
A cell identity;
Information on one or more channels of which configuration is successful;
Information on one or more channels of which configuration is failed.

The information on the channel of which configuration is successful includes, but is not limited to, at least one of the following information:
At least one piece of information of the configuration information of the channel, such as a channel ID.

The information on the channel of which configuration is failed includes, but is not limited to, at least one of the following information:
At least one piece of information of the configuration information of the channel, such as a channel ID;
At least one piece of information of the updated information on the channel of which configuration needs to be changed;
A cause.

The information on the cell of which configuration is failed includes, but is not limited to, at least one of the following information:
A cell identity.

For at least one piece of information of the information on the channel of which configuration needs to be changed, Node 2 can configure different values or generate different proposed values. The configured value or the generated proposed value may be included by at least one piece of information of the updated information on the channel of which configuration needs to be changed.

If the flag indicating that the channel used for the initial random access needs to be changed is set in the indication message, Node 2 may select a channel as a new channel used for the initial random access. The information on the new channel is included in at least one piece of information of the configuration information of the channel used for the initial random access.

The inter-node interface can be an Xn interface, an X2 interface, an F1 interface, an Ng interface or an S1 interface. The inter-node interface may also be an interface between two gNB-DUs.

When the inter-node interface is an Xn interface, the inter-node interface message includes, but is not limited to, at least one of the following messages: XN SETUP REQUEST, XN SETUP RESPONSE, XN SETUP FAILURE, NG-RAN NODE CONFIGURATION UPDATE, NG-RAN NODE CONFIGURATION UPDATE ACKNOWLEDGE, NG-RAN NODE CONFIGURATION UPDATE FAILURE, CELL ACTIVATION REQUEST, CELL ACTIVATION RESPONSE, CELL ACTIVATION FAILURE, RESET REQUEST, RESET RESPONSE, S-NODE ADDITION REQUEST, S-NODE ADDITION REQUEST ACKNOWLEDGE, S-NODE ADDITION REQUEST REJECT, S-NODE MODIFICATION REQUEST, S-NODE MODIFICATION REQUEST ACKNOWLEDGE, S-NODE MODIFICATION REQUEST REJECT, S-NODE MODIFICATION REQUIRED, S-NODE MODIFICATION CONFIRM, S-NODE MODIFICATION REFUSE, S-NODE CHANGE REQUIRED, S-NODE CHANGE CONFIRM, S-NODE CHANGE REFUSE, and a newly defined Xn message.

When the inter-node interface is an X2 interface, the inter-node interface message includes, but is not limited to, at least one of the following messages: X2 SETUP REQUEST, X2 SETUP RESPONSE, X2 SETUP FAILURE, RESET REQUEST, RESET RESPONSE, ENB CONFIGURATION UPDATE, ENB CONFIGURATION UPDATE ACKNOWLEDGE, ENB CONFIGURATION UPDATE FAILURE, CELL ACTIVATION REQUEST, CELL ACTIVATION RESPONSE, CELL ACTIVATION FAILURE, EN-DC X2 SETUP REQUEST, EN-DC X2 SETUP RESPONSE, EN-DC X2 SETUP FAILURE, EN-DC CONFIGURATION UPDATE, EN-DC CONFIGURATION UPDATE ACKNOWLEDGE, EN-DC CONFIGURATION UPDATE FAILURE, EN-DC CELL ACTIVATION REQUEST, EN-DC CELL ACTIVATION RESPONSE, EN-DC CELL ACTIVATION FAILURE, EN-DC CONFIGURATION TRANSFER, SGNB ADDITION REQUEST, SGNB ADDITION REQUEST ACKNOWLEDGE, SGNB ADDITION REQUEST REJECT, SGNB MODIFICATION REQUEST, SGNB MODIFICATION REQUEST ACKNOWLEDGE, SGNB MODIFICATION REQUEST REJECT, SGNB MODIFICATION REQUIRED, SGNB MODIFICATION CONFIRM, SGNB MODIFICATION REFUSE, SGNB CHANGE REQUIRED, SGNB CHANGE CONFIRM, SGNB CHANGE REFUSE, SENB ADDITION REQUEST, SENB ADDITION REQUEST ACKNOWLEDGE, SENB ADDITION REQUEST REJECT, SENB MODIFICATION REQUEST, SENB MODIFICATION REQUEST ACKNOWLEDGE, SENB MODIFICATION REQUEST REJECT, SENB MODIFICATION REQUIRED, SENB MODIFICATION CONFIRM, SENB MODIFICATION REFUSE, and a newly defined X2 message.

When the inter-node interface is an F1 interface, the inter-node interface message include, but is not limited to, at least one of the following messages: F1 SETUP REQUEST, F1 SETUP RESPONSE, F1 SETUP FAILURE, RESET, RESET ACKNOWLEDGE, GNB-DU CONFIGURATION UPDATE, GNB-DU CONFIGURATION UPDATE ACKNOWLEDGE, GNB-DU CONFIGURATION UPDATE FAILURE, GNB-CU CONFIGURATION UPDATE, GNB-CU CONFIGURATION UPDATE ACKNOWLEDGE, GNB-CU CONFIGURATION UPDATE FAILURE, and a newly defined F1 message.

When the inter-node interface is an Ng interface, the inter-node interface message includes, but is not limited to, at least one of the following messages: RAN CONFIGURATION UPDATE, RAN CONFIGURATION UPDATE ACKNOWLEDGE, AMF CONFIGURATION UPDATE, AMF CONFIGURATION UPDATE ACKNOWLEDGE, NG RESET, NG RESET ACKNOWLEDGE, UPLINK RAN CONFIGURATION TRANSFER, DOWNLINK RAN CONFIGURATION TRANSFER, and a newly defined Ng message.

When the inter-node interface is an S1 interface, the inter-node interface message includes, but is not limited to, at least one of the following messages: ENB CONFIGURATION UPDATE, ENB CONFIGURATION UPDATE ACKNOWLEDGE, MME CONFIGURATION UPDATE, MME CONFIGURATION UPDATE ACKNOWLEDGE, eNB DIRECT INFORMATION TRANSFER, MME DIRECT INFORMATION TRANSFER, eNB CONFIGURATION TRANSFER, MME CONFIGURATION TRANSFER, and a newly defined S1 message.

When the inter-node interface is an interface between two gNB-DUs, the inter-node interface message may include, for example, but is not limited to, at least one of the following messages: a message related to setting or resetting the interface, and a message related to node configuration update.

Through the procedure, Node 1 can indicate the parameters configured for the channel to Node 2. Node 2 can perform configuration according to the indication of Node 1, or can decide the parameters configured for the channel by itself, and/or generate the proposed values of the parameters configured for the channel. In this way, poor configuration parameters among different nodes can be avoided, thus eliminating the resulting problems, such a LBT failure.

### Problem 3:

At present, in a mobility scenario of a UE, for example, in the procedure of a handover or change of a Secondary Node (SN), when selecting a target cell, the main consideration is the signal quality and/or load state of a candidate cell received by the UE. However, in a deployment scenario of an unlicensed spectrum, it is also necessary to consider parameters related to the unlicensed spectrum, such as the load state of the candidate cell in the unlicensed spectrum. Otherwise, if the selected target cell is overloaded on the deployed unlicensed spectrum, for example, the measurement result of the target cell on the deployed unlicensed spectrum, such as a RSSI or a CO, is relatively high, the target cell is prone to occurring a LBT failure, resulting in a wireless connection failure, for example, during or after the handover or during or after the SN change procedure, thus affecting the user experience.

Another method for self-configuration and self-optimization includes the following steps.

Node 1 can send request information to Node 2 through an inter-node interface message, and the request information requires Node 2 to report the load information of licensed spectrums and/or unlicensed spectrums of one or more cells. The request information includes, but is not limited to, at least one of the following information:
A cell identity;
Configuration information of load information of a channel used by one or more beams;
Configuration information of load information of one or more slices;
Configuration information of load information of a channel used by one or more Public Land Mobile Networks (PLMNs);
Configuration information of load information of a channel used by one or more Non-Public Networks (NPNs);
Configuration information of load information of a channel.

The configuration information of the load information of the channel used by the beam includes at least one of the following information:
An identification of the beam, such as a SSB index;
Configuration information of load information of the channel.

The configuration information of the load information of the channel used by the slice includes at least one of the following information:
An identification of the slice, such as a S-NSSAI;
Configuration information of load information of the channel.

The configuration information of the load information of the channel used by the PLMN includes at least one of the following information:
A PLMN identification ID;
Configuration information of load information of the channel.

The configuration information of the load information of the channel used by the NPN includes at least one of the following information:
An identification of the NPN, such as a NID or a CAG ID;
A PLMN identification ID;
Configuration information of load information of the channel.

The configuration information of the load information of the channel includes, but is not limited to, at least one of the following information:
At least one piece of information of the configuration information of the channel, such as a channel ID;
A measuring interval length;
A flag indicating whether a measurement is periodic;
A measuring period length.

The cell required to report can belong to a node other than Node 2, such as the adjacent nodes to Node 2.

Node 2 sends the requested load information of the licensed spectrum and/or the unlicensed spectrum to Node 1 through the inter-node interface message. The load information of the licensed spectrum and/or the unlicensed spectrum includes one or more of the following information:
A cell identity;
Load information of a channel used by one or more beam;
Load information of a channel used by one or more slice;
Load information of a channel used by one or more Public Land Mobile Networks (PLMNs);
Load information of a channel used by one or more Non-Public Networks (NPNs);
Load information of a channel.

The load information of the channel used by the beam includes at least one of the following information:
A beam identification, such as a SSB index;
Load information of the channel.

The load information of the slice includes at least one of the following information:
An identification of the slice, such as S-NSSAI;
Load information of a channel used by the slice;
A proportion of the least physical resources that the slice can use to all physical resources;
A proportion of the most physical resources that the slice can use to all physical resources.

The load information of the channel used by the PLMN includes at least one of the following information:
A PLMN identification ID;
Load information of the channel.

The load information of the channel used by the NPN includes at least one of the following information:
An identification of the NPN, such as a NID or a CAG ID;
A PLMN identification ID;
Load information of the channel.

The load information of the channel includes, but is not limited to, at least one of the following information:
At least one piece of information of the configuration information of the channel, such as a channel ID;
A RSSI (Received Signal Strength Indicator);
A CO (channel occupancy ratio/percentage);
A number of LBT failures;
A success ratio (percentage) or failure ratio (percentage) of LBT;
An average sending duration after a successful LBT;
A transmit power;
A maximum transmit power;
A flag indicating whether to enable uplink and downlink shared channel occupation (COT sharing);
A number of time slots used for the uplink and downlink shared channel occupation;
A position of time slot used for the uplink and downlink shared channel occupation;
An ED threshold used for the uplink and downlink shared channel occupation;
A channel access priority used for the uplink and downlink shared channel occupation;
A number of consecutive LBT failures;
A detection duration used to detect consecutive LBT failures;
A maximum number for detecting consecutive LBT failures;
A proportion of available or unavailable physical resources to all physical resources.

The unavailable physical resources include at least one of the following information:
Physical resources occupied by other nodes;
Physical resources occupied by the present node;
A sum of the above two.

The available physical resources include at least one of the following information:
Physical resources not occupied by other nodes and still not occupied by the present node;
Physical resources not occupied by other nodes but already occupied by the present node;
A sum of the above two.

The all physical resources include at least one of the following information:
Physical resources not occupied by other nodes among all configured physical resources;
All configured physical resources.

The physical resources may be the number of PRBs.

For example, the proportion of available physical resources to all physical resources can be the proportion of physical resources not occupied by other nodes and still not occupied by the present node to all configured physical resources. The proportion of unavailable physical resources to all physical resources can be the proportion of physical resources occupied by the present node to all configured physical resources, or the proportion of a sum of physical resources occupied by the present node and physical resources occupied by other nodes to all configured physical resources.

The CO can be one or more of the following information:
A CO indicating that the channel is occupied by other nodes;
A CO indicating that the channel is occupied by the present node;
A CO indicating that a total of the channel occupied by other nodes and the present node.

The CO can be the proportion of the number of RSSI samples exceeding a predetermined threshold to the total number of samples. In addition, other parameters, such as time proportion, may be used instead of the CO, for example, the length of time the channel is occupied by other nodes within a unit time, or the proportion of the length of time to the unit time. The following description is omitted for avoiding redundancy.

The parameters related to detecting consecutive LBT failures are used to decide whether consecutive LBT failures occurs, and the parameters related to uplink and downlink shared channel occupation and/or the number of consecutive LBT failures can be used to evaluate the state of the corresponding channel, such as the busy and idle states of the channel, which can be used for self-configuration and self-optimization, such as deciding the strategy of load balancing.

The load information of the channel can reflect the load state of a channel. For example, the RSSI is relatively low, or the CO is relatively low, or the number of LBT failures is relatively few, or the LBT success ratio (percentage) is relatively high or the failure ratio (percentage) is relatively low, which indicates that the load of this channel is light and it can accept more loads, such as more UEs.

Node 2 can also actively send the load information of the owned unlicensed spectrum to Node 1, and the load information can come from other nodes.

Node 1 and Node 2 may be different access nodes, such as different gNBs or different eNBs, may be different units belonging to an access node, such as a gNB-DU and a gNB-CU, may be an access node and a core network node, such as a gNB and an AMF, or an eNB and a MME, may be a secondary node and a master node in a dual-connectivity or multi-connectivity scenario, may be different units belonging to one or more access nodes, such as different gNB-DUs, or may be a UE and an access node.

The inter-node interface can be an Xn interface, an X2 interface, an F1 interface, an Ng interface, an S1 interface, or an interface between a UE and an access node. The inter-node interface may also be an interface between two gNB-DUs.

When the inter-node interface is an Xn interface, the inter-node interface message includes, but is not limited to, at least one of the following messages: XN SETUP REQUEST, XN SETUP RESPONSE, NG-RAN NODE CONFIGURATION UPDATE, NG-RAN NODE CONFIGURATION UPDATE ACKNOWLEDGE, S-NODE ADDITION REQUEST, S-NODE ADDITION REQUEST ACKNOWLEDGE, S-NODE MODIFICATION REQUEST, S-NODE MODIFICATION REQUEST ACKNOWLEDGE, S-NODE MODIFICATION REQUIRED, S-NODE MODIFICATION CONFIRM, S-NODE CHANGE REQUIRED, S-NODE CHANGE CONFIRM, RESOURCE STATUS REQUEST, RESOURCE STATUS UPDATE, HANDOVER REQUEST, HANDOVER REQUEST ACKNOWLEDGE, and a newly defined Xn message.

When the inter-node interface is an X2 interface, the inter-node interface message includes, but is not limited to, at least one of the following messages: X2 SETUP REQUEST, X2 SETUP RESPONSE, ENB CONFIGURATION UPDATE, ENB CONFIGURATION UPDATE ACKNOWLEDGE, EN-DC X2 SETUP REQUEST, EN-DC X2 SETUP RESPONSE, EN-DC CONFIGURATION UPDATE, EN-DC CONFIGURATION UPDATE ACKNOWLEDGE, EN-DC CONFIGURATION TRANSFER, SGNB ADDITION REQUEST, SGNB ADDITION REQUEST ACKNOWLEDGE, SGNB MODIFICATION REQUEST, SGNB MODIFICATION REQUEST ACKNOWLEDGE, SGNB MODIFICATION REQUIRED, SGNB MODIFICATION CONFIRM, SGNB CHANGE REQUIRED, SGNB CHANGE CONFIRM, SENB ADDITION REQUEST, SENB ADDITION REQUEST ACKNOWLEDGE, SENB MODIFICATION REQUEST, SENB MODIFICATION REQUEST ACKNOWLEDGE, SENB MODIFICATION REQUIRED, SENB MODIFICATION CONFIRM, RESOURCE STATUS REQUEST, RESOURCE STATUS UPDATE, EN-DC RESOURCE STATUS REQUEST, EN-DC RESOURCE STATUS UPDATE, HANDOVER REQUEST, HANDOVER REQUEST ACKNOWLEDGE, and a newly defined X2 message.

When the inter-node interface is an F1 interface, the inter-node interface message includes, but is not limited to, at least one of the following messages: F1 SETUP REQUEST, F1 SETUP RESPONSE, GNB-DU CONFIGURATION UPDATE, GNB-DU CONFIGURATION UPDATE ACKNOWLEDGE, GNB-CU CONFIGURATION UPDATE, GNB-CU CONFIGURATION UPDATE ACKNOWLEDGE, RESOURCE STATUS REQUEST, RESOURCE STATUS UPDATE, and a newly defined F1 message.

When the inter-node interface is an Ng interface, the inter-node interface message includes, but is not limited to, at least one of the following messages: NG SETUP REQUEST, NG SETUP RESPONSE, RAN CONFIGURATION UPDATE, RAN CONFIGURATION UPDATE ACKNOWLEDGE, AMF CONFIGURATION UPDATE, AMF CONFIGURATION UPDATE ACKNOWLEDGE, UPLINK RAN CONFIGURATION TRANSFER, DOWNLINK RAN CONFIGURATION TRANSFER, HANDOVER REQUIRED, HANDOVER COMMAND, HANDOVER REQUEST, HANDOVER REQUEST ACKNOWLEDGE, and a newly defined Ng message.

When the inter-node interface is an S1 interface, the inter-node interface message includes, but is not limited to, at least one of the following messages: S1 SETUP REQUEST, S1 SETUP RESPONSE, ENB CONFIGURATION UPDATE, ENB CONFIGURATION UPDATE ACKNOWLEDGE, MME CONFIGURATION UPDATE, MME CONFIGURATION UPDATE ACKNOWLEDGE, eNB DIRECT INFORMATION TRANSFER, MME DIRECT INFORMATION TRANSFER, eNB CONFIGURATION TRANSFER, MME CONFIGURATION TRANSFER, HANDOVER REQUIRED, HANDOVER COMMAND, HANDOVER REQUEST, HANDOVER REQUEST ACKNOWLEDGE, and a newly defined S1 message.

When the inter-node interface is an interface between a UE and an access node, the inter-node interface message includes, but is not limited to, at least one of the following messages: RRCReconfiguration, and a newly defined message.

When the inter-node interface is an interface between two gNB-DUs, the inter-node interface message may include, for example, but is not limited to, at least one of the following messages: a message related to setting or resetting the interface, and a message related to node configuration update.

After the node receives the load information of the unlicensed spectrum, for example, after the access node or CU receives the load information of the unlicensed spectrum of other access nodes or DUs, the node can use the information for self-configuration or self-optimization, for example, take the load information of the unlicensed spectrum as the basis for selecting the target cell in the handover. After self-configuration or self-optimization, the access node avoids selection of inappropriate target cells in the subsequent handover procedure, and enhances the user experience.

### Problem 4:

When a UE initially accesses a cell, the cell will broadcast the radio resources used for the initial random access, and the resources will be provided to all UEs that need to perform the initial random access for use. In the deployment scenario of unlicensed spectrum, if adjacent cells use the same radio resource, such as the same channel, it may cause interference on other cells, for example, a LBT failure occurs, resulting in failure of the initial random access of other cell. Since the initial random access is the first step for the UE to connect to an access node, if the initial random access fails, the UE cannot connect to the access node, which greatly degrades the user experience.

Adjacent cells can exchange their respective radio resources used for the initial random access, such as the used channel information, to avoid using the same radio resources used for the initial random access with each other and avoid an unnecessary initial random access failure.

In addition, after the random access procedure, the UE can generate a random access related report. For the random access procedure using the unlicensed spectrum, the information related to the unlicensed spectrum can be recorded in the report, providing a basis for the access node to self-configure and self-optimize the random access.

Another method for self-configuration and self-optimization includes the following steps:

Node 1 can send the channel information corresponding to the radio resource used for the initial random access of one or more cells to Node 2 through the inter-node interface message. This can be achieved by two methods.

Method 1: as described in the first method for self-configuration and self-optimization, Node 1 may send channel information of one or more cells to Node 2 through an inter-node interface message, where the information includes information for indicating PRACH configuration parameters currently used for the initial random access, for example, a flag is set to be true in the channel information corresponding to radio resources used for the initial random access, and the flag is a flag indicating whether this channel is used for the initial random access.

Method 2: in the existing mechanism, Node 1 can send at least one set of Physical Random Access CHannel (PRACH) Configuration parameters used by at least one cell to Node 2 through an inter-node interface message, and the parameters include a parameter identifying the spectrum used by the PRACH. The method adds, to the PRACH configuration parameters, a flag indicating whether the PRACH configuration parameters are used for the initial random access. In this way, Node 2 can infer which channel is used for the initial random access according to the spectrum used by the PRACH used for the initial random access in the PRACH configuration parameters and then according to the channel information of the corresponding cell sent by Node 1 in the first method for self-configuration and self-optimization.

After a node knows which channel is used for the initial random access by an adjacent node, it can select a different channel used for the initial random access. In this way, it can avoid using the same channel used for the initial random access between adjacent nodes, thus reducing the possibility of the initial random access failure, such as the initial random access failure caused by a LBT failure.

Node 1 and Node 2 may be different access nodes, such as different gNBs or different eNBs, may be different units belonging to an access node, such as a gNB-DU and a gNB-CU, may be an access node and a core network node, such as a gNB and an AMF, or an eNB and a MME, may be a secondary node and a master node in a dual-connectivity or multi-connectivity scenario, or may be different units belonging to one or more access nodes, such as different gNB-DUs.

The inter-node interface can be an Xn interface, an X2 interface, an F1 interface, an Ng interface, or an S1 interface. The inter-node interface may also be an interface between two gNB-DUs.

When the inter-node interface is an Xn interface, the inter-node interface message includes, but is not limited to, at least one of the following messages: XN SETUP REQUEST, XN SETUP RESPONSE, NG-RAN NODE CONFIGURATION UPDATE, NG-RAN NODE CONFIGURATION UPDATE ACKNOWLEDGE, CELL ACTIVATION REQUEST, CELL ACTIVATION RESPONSE, RESET REQUEST, RESET RESPONSE, S-NODE ADDITION REQUEST, S-NODE ADDITION REQUEST ACKNOWLEDGE, S-NODE MODIFICATION REQUEST, S-NODE MODIFICATION REQUEST ACKNOWLEDGE, S-NODE MODIFICATION REQUIRED, S-NODE MODIFICATION CONFIRM, S-NODE CHANGE REQUIRED, S-NODE CHANGE CONFIRM, and a newly defined Xn message.

When the inter-node interface is an X2 interface, the inter-node interface message includes, but is not limited to, at least one of the following messages: X2 SETUP REQUEST, X2 SETUP RESPONSE, RESET REQUEST, RESET RESPONSE, ENB CONFIGURATION UPDATE, ENB CONFIGURATION UPDATE ACKNOWLEDGE, CELL ACTIVATION REQUEST, CELL ACTIVATION RESPONSE, EN-DC X2 SETUP REQUEST, EN-DC X2 SETUP RESPONSE, EN-DC CONFIGURATION UPDATE, EN-DC CONFIGURATION UPDATE ACKNOWLEDGE, EN-DC CELL ACTIVATION REQUEST, EN-DC CELL ACTIVATION RESPONSE, EN-DC CONFIGURATION TRANSFER, SGNB ADDITION REQUEST, SGNB ADDITION REQUEST ACKNOWLEDGE, SGNB MODIFICATION REQUEST, SGNB MODIFICATION REQUEST ACKNOWLEDGE, SGNB MODIFICATION REQUIRED, SGNB MODIFICATION CONFIRM, SGNB CHANGE REQUIRED, SGNB CHANGE CONFIRM, SENB ADDITION REQUEST, SENB ADDITION REQUEST ACKNOWLEDGE, SENB MODIFICATION REQUEST, SENB MODIFICATION REQUEST ACKNOWLEDGE, SENB MODIFICATION REQUIRED, SENB MODIFICATION CONFIRM, and a newly defined X2 message.

When the inter-node interface is an F1 interface, the inter-node interface message includes, but is not limited to, at least one of the following messages: F1 SETUP REQUEST, F1 SETUP RESPONSE, RESET, RESET ACKNOWLEDGE, GNB-DU CONFIGURATION UPDATE, GNB-DU CONFIGURATION UPDATE ACKNOWLEDGE, GNB-CU CONFIGURATION UPDATE, GNB-CU CONFIGURATION UPDATE ACKNOWLEDGE, and a newly defined F1 message.

When the inter-node interface is an Ng interface, the inter-node interface message includes, but is not limited to, at least one of the following messages: NG SETUP REQUEST, NG SETUP RESPONSE, RAN CONFIGURATION UPDATE, RAN CONFIGURATION UPDATE ACKNOWLEDGE, AMF CONFIGURATION UPDATE, AMF CONFIGURATION UPDATE ACKNOWLEDGE, NG RESET, RESET ACKNOWLEDGE, UPLINK RAN CONFIGURATION TRANSFER, DOWNLINK RAN CONFIGURATION TRANSFER, and a newly defined Ng message.

When the inter-node interface is an S1 interface, the inter-node interface message includes, but is not limited to, at least one of the following messages: S1 SETUP REQUEST, S1 SETUP RESPONSE, RESET, RESET ACKNOWLEDGE, ENB CONFIGURATION UPDATE, ENB CONFIGURATION UPDATE ACKNOWLEDGE, MME CONFIGURATION UPDATE, MME CONFIGURATION UPDATE ACKNOWLEDGE, eNB DIRECT INFORMATION TRANSFER, MME DIRECT INFORMATION TRANSFER, eNB CONFIGURATION TRANSFER, MME CONFIGURATION TRANSFER, and a newly defined S1 message.

When the inter-node interface is an interface between two gNB-DUs, the inter-node interface message may include, for example, but is not limited to, at least one of the following messages: a message related to setting or resetting the interface, and a message related to node configuration update.

The UE may generate a random access related report after the random access procedure. For example, when the UE fails in a random access, it may generate a report of the failure, which may be a Connection Establishment Failure (CEF) report. When the UE succeeds in a random access, it may generate a report of the random access, which may be a Random Access report.

The random access related report may include at least one of the following information:
A center frequency of the spectrum used for the random access;
A bandwidth of the spectrum used for the random access;
A starting frequency of the spectrum used for the random access;
An ending frequency of the spectrum used for the random access;
A RSSI;
A CO;
A number of LBT failures;
A success ratio (percentage) or failure ratio (percentage) of LBT;
An average sending duration after successful LBT;
An ED threshold;
A maximum ED threshold;
An ED threshold offset;
A flag indicating whether there is another access technology that uses the same spectrum resource;
A channel access priority (channelAccessPriority);
A cause, such as lbt-failure (listen before talk failure).

The spectrum related parameter can identify a channel, the RSSI, the CO and the LBT related measurement result can be used to reflect the busy and idle states of the current channel, and the ED threshold related parameter is used to generate the measurement result.

The random access related report can be sent to the access node where the random access occurs according to the existing mechanism. The access node can use the report for self-configuration or self-optimization, for example, judging whether the currently used random access resources are appropriate according to these reports. After self-configuration or self-optimization, the access node avoids similar failures in the future and enhances the user experience.

### Problem 5:

In the scenario of unlicensed spectrum deployment, in the procedure of handover or establishment of a dual-connectivity or multi-connectivity, the UE may fails in handover or establishment of a dual-connectivity or multi-connectivity due to a LBT failure.

After the handover procedure or the procedure of establishment of a dual-connectivity or multi-connectivity, the UE may generate a mobility related report, and the information related to the unlicensed spectrum may be recorded in the report, thus providing a basis for the access node to self-configure and self-optimize the handover procedure.

Another method for self-configuration and self-optimization includes the following steps.

After the handover procedure or the procedure of establishment of a dual-connectivity or multi-connectivity, the UE may generate the mobility related report. For example, when the UE fails in a handover or fails in establishing a dual-connectivity or multi-connectivity, it may generate a report of the failure, which may be a Radio Link Failure (RLF) report or secondary cell group failure information (SCGFailureInformation). When the UE succeeds in the handover, it may generate a report of the handover, which may be a Successful Handover report.

The handover related report may include at least one of the following information:
A center frequency of a spectrum used for connection with a source access node;
A bandwidth of the spectrum used for the connection with the source access node;
A starting frequency of the spectrum used for the connection with the source access node;
An ending frequency of the spectrum used for the connection with the source access node;
A RSSI for the connection with the source access node;
A CO for the connection with the source access node;
A number of LBT failures for the connection with the source access node;
A success ratio (percentage) or failure ratio (percentage) of LBT for the connection with the source access node;
An average sending duration after successful LBT for the connection with the source access node;
An ED threshold for the connection with the source access node;
A maximum ED threshold for the connection with the source access node;
An ED threshold offset for the connection with the source access node;
A flag, configured by the source access node, indicating whether there is another access technology that uses the same spectrum resource;
A channel access priority (channelAccessPriority) for the connection with the source access node;
A center frequency of a spectrum used for connection with a target access node;
A bandwidth of the spectrum used for the connection with the target access node;
A starting frequency of the spectrum used for the connection with the target access node;
An ending frequency of the spectrum used for the connection with the target access node;
A RSSI for the connection with the target access node;
A CO for the connection with the target access node;
A number of LBT failures for the connection with the target access node;
A success ratio (percentage) or failure ratio (percentage) of LBT for the connection with the target access node;
An average sending duration after successful LBT for the connection with the target access node;
An ED threshold for the connection with the target access node;
A maximum ED threshold for the connection with the target access node;
An ED threshold offset for the connection with the target access node;
A flag, configured by the target access node, indicating whether there is another access technology that uses the same spectrum resource;
A Channel access priority (channelAccessPriority) for the connection with the target access node;
A Cause, such as lbt-failure (listen before talk failure).

A spectrum related parameter can identify a channel, the RSSI, the CO and the LBT related measurement result can be used to reflect the busy and idle states of the current channel, and the ED threshold related parameters are used to generate the measurement result.

The mobility related report can be sent to the source access node of the handover or the access node where the RLF occurs, or the node initiating the establishment of a dual-connectivity or multi-connectivity or the node initiating the change of the dual-connectivity or multi-connectivity according to the existing mechanism. The access node can use the report for self-configuration or self-optimization, for example, judging whether the selection mechanism for the target cell is appropriate according to these reports (for example, if the RSSI or CO for the connection with the target access node is high, it means that the target cell is not a suitable target cell), or whether the resource configuration of the target cell for the handover is appropriate (for example, if the ED threshold related parameter for the connection with the target access node is high or low, it means that correct measurement results cannot be generated), or whether the timing of the handover is appropriate (for example, if the RSSI or the CO for the connection with the source access node is high, it means that the timing of the handover may be too late), or whether the measurement settings of the source node about the unlicensed spectrum are appropriate (for example, if the ED threshold related parameter for the connection with the source access node is high or low, it means that correct measurement results cannot be generated). After self-configuration or self-optimization, the access node prevents similar failures from occurring in the future and enhances the user experience.

### Problem 6:

In the existing mechanism, the network can configure MDT (minimization of drive test), and requires the access node and the UE to report the measurement result of parameters designated in the MDT configuration, and the access node is responsible for collecting the measurement result and sending them to the address designated by the network.

At present, the MDT configuration includes no parameter related to unlicensed spectrum, which also means that in the deployment scenario of unlicensed spectrum, the network cannot judge the current state of the network, nor can it find possible problems.

Another method for self-configuration and self-optimization includes the following steps.

Node 1 can send a piece of configuration information to Node 2 through an inter-node interface message, and the configuration information can be MDT configuration information. The MDT configuration information includes, but is not limited to, at least one of the following information:
A category flag indicating MDT measurement for the unlicensed spectrum, such as a RSSI measurement, or a CO measurement, or a measurement of a number of LBT failures, or a measurement LBT success/failure ratio (percentage) event;
A flag indicating the MDT measurement for the unlicensed spectrum on the UE side;
MDT measurement related information for the unlicensed spectrum on the UE side;
A flag indicating the MDT measurement for the unlicensed spectrum on the access node side;
MDT measurement related information for the unlicensed spectrum on the access node side.

The MDT measurement related information includes at least one of the following information:
A flag indicating whether it is an Immediate MDT measurement (ImmediateMDT) or a logged MDT measurement (logged MDT);
A time interval recording the MDT measurement;
A length of time recording the MDT measurement;
Information on the unlicensed spectrum related to the measurement;
Measurement report related information.

The measurement report related information includes at least one of the following information:
A flag indicating whether it is a timing report or an event-triggered report;
A time interval of the timing report;
A length of time of the timing report;
Parameters related to the measurement result required to be reported, including, but not limited to, at least one of the following: a RSSI, a CO, a number of LBT failures, a LBT success/failure ratio (percentage), available or unavailable physical resources, and a proportion of available or unavailable physical resources to all physical resources;
A flag of an event-triggered report, such as a RSSI event, a CO event, a number of LBT failures, an event of a LBT success/failure ratio (percentage), an event of available or unavailable physical resources, and an event of the proportion of the available or unavailable physical resources to all physical resources, and the event may be that the parameter related to the measurement result is lower than or exceeds a threshold;
A threshold of a RSSI that triggers reporting;
A duration that a RSSI exceeds the threshold;
A threshold of a RSSI that stops reporting;
A hysteresis parameter of a RSSI that triggers or stops reporting;
A threshold of a CO that triggers reporting;
A duration that a CO exceeds the threshold;
A threshold of a CO that stops reporting;
A hysteresis parameter of a CO that triggers or stops reporting;
A threshold of the number of LBT failures that triggers reporting;
A duration that the number of LBT failures exceeds the threshold;
A threshold of the number of LBT failures that stops reporting;
A hysteresis parameter of the number of LBT failures that triggers or stops reporting;
A threshold of the LBT success/failure ratio (percentage) that triggers reporting;
A duration that the LBT success/failure ratio (percentage) is lower than or exceeds the threshold;
A threshold of the LBT success/failure ratio (percentage) that stops reporting;
A hysteresis parameter of the LBT success/failure ratio (percentage) that triggers or stops reporting;
A threshold of the available or unavailable physical resources that triggers reporting;
A duration that the available or unavailable physical resources is lower than or exceeds the threshold;
A threshold of the available or unavailable physical resources that stops reporting;
A hysteresis parameter of the available or unavailable physical resources that triggers or stops reporting;
A threshold of the proportion of the available or unavailable physical resources to all physical resources that triggers reporting;
A duration that the proportion of the available or unavailable physical resources to all physical resources is lower than or exceeds the threshold;
A threshold of the proportion of the available or unavailable physical resources to all physical resources that stops reporting;
A hysteresis parameter of the proportion of the available or unavailable physical resources to all physical resources that triggers or stops reporting;
A flag indicating whether there is another access technology that uses the same spectrum resource.

The information on the unlicensed spectrum related to the measurement includes, but is not limited to, at least one of the following: a channel ID, a center frequency, a bandwidth, a starting frequency, an ending frequency and a channel access priority.

The threshold, and/or the duration, and/or the hysteresis parameter may have only one value for all events.

Node 2 generates a MDT measurement report according to the MDT configuration information. The MDT measurement report includes, but is not limited to, at least one of the following information:
A center frequency of the measured spectrum;
A bandwidth of the measured spectrum;
A starting frequency of the measured spectrum;
An ending frequency of the measured spectrum;
A RSSI;
A CO;
A number of LBT failures;
A Success ratio (percentage) or failure ratio (percentage) of LBT;
An average sending duration after successful LBT;
An ED threshold;
A maximum ED threshold;
An ED threshold offset;
A flag indicating whether there is another access technology that uses the same spectrum resource;
A channel ID;
A channel access priority;
Available or unavailable physical resources;
A proportion of available or unavailable physical resources to all physical resources;
A flag indicating that this measurement occurs on the UE side;
A flag indicating that this measurement occurs on the access node side;
A cell identity;
An identification of the node where the cell is located;
A beam identification;
A slice identification;
A Public Land Mobile Network (PLMN) identification.

Node 2 sends the MDT measurement report to the network according to the existing mechanism.

Node 1 and Node 2 may be different access nodes, such as different gNBs or different eNBs, may be different units belonging to an access node, such as a gNB-CU and a gNB-DU, may be a core network node and an access node, such as an AMF and a gNB, or a MME and an eNB, may be a secondary node and a master node in a dual-connectivity or multi-connectivity scenario, or may be different units belonging to one or more access nodes, such as different gNB-DUs.

The inter-node interface can be an Xn interface, an X2 interface, an F1 interface, an Ng interface, or an S1 interface. The inter-node interface may also be an interface between two gNB-DUs.

The inter-node interface message is the same as the existing mechanism.

In the procedure, the access node may send measurement configuration to the UE, and the measurement configuration may include at least one of the following information:
A channel ID;
A center frequency;
A bandwidth;
A starting frequency;
An ending frequency;
A flag indicating to perform the measurement of the number of LBT failures;
A flag indicating to perform the measurement of the LBT success/failure ratio (percentage);
A flag indicating to perform the measurement of the average LBT successful sending time;
A flag indicating to perform the measurement of the available or unavailable physical resources;
A flag indicating to perform the measurement of the proportion of available or unavailable physical resources to all physical resources.

The UE generates a measurement report according to the measurement configuration, and the measurement report may include at least one of the following information:
A number of LBT failures;
A LBT success/failure ratio (percentage);
An average LBT successful sending time;
An ED threshold;
A maximum ED threshold;
An ED threshold offset;
A flag indicating whether to enable uplink and downlink shared channel occupation (COT sharing);
A number of time slots used for uplink and downlink shared channel occupation;
A position of time slots used for uplink and downlink shared channel occupation;
An ED threshold used for uplink and downlink shared channel occupation;
A channel access priority used for uplink and downlink shared channel occupation;
A number of consecutive LBT failures;
A detection duration used to detect consecutive LBT failures;
A maximum number for detecting consecutive LBT failures;
A channel ID;
Available or unavailable physical resources

A proportion of available or unavailable physical resources to all physical resources.

The network accepts these MDT measurement reports, and can judge the current state of the network according to the MDT measurement reports and find possible problems.

### Problem 7:

The existing mechanism supports two handovers, CHO (Conditional Handover) and DAPS HO (Dual Active Protocol Stack Handover).

CHO: The network configures for the UE a list of candidate cell and handover conditions for handover, and the UE selects one of the cells meeting the handover conditions as the target cell. The purpose is to improve the reliability of handover.

DAPS HO: In the procedure of handover, the UE keeps connection with the source access node and the target access node at the same time. If the handover is successful, the connection between the UE and the source and target access nodes is released; otherwise, the UE reverts to the state before handover. The purpose is to reduce the service interruption time in the procedure of handover.

For the CHO, before the UE starts to perform the handover, the source access node can forward data to all possible target access nodes in advance. This brings the pressure of caching data to the target access node.

For the DAPS HO, at present, the network lacks the means to judge whether the purpose of reducing the service interruption time is achieved in the procedure of DAPS HO.

Another method for self-configuration and self-optimization includes the following steps.

Node 1 sends Message 1 to Node 2 through an inter-node interface message to request a handover. Node 2 sends Message 2 to Node 1 through an inter-node interface message to indicate the response to the request, such as accepting or rejecting the handover. The message may include at least one of the following information:
A flag indicating whether forwarding data in advance is acceptable;
A maximum acceptable amount of the data forwarded in advance that needs to be cached.

According to the received information, Node 1 can judge whether it is appropriate to forward data to Node 2 in advance, so as to avoid overload of Node 2.

In addition, Node 1 may also send Message 3 to Node 3, the message includes a piece of information related to the unlicensed spectrum, and the information includes, but is not limited to, at least one of the following information:
A Cell identity, such as a PCI;
At least one piece of information of configuration information of a channel, such as a channel ID;
A RSSI measured by the cell on the channel;
A CO measured by the cell on the channel;
A number of LBT failures measured by the cell on the channel;
A success ratio (percentage) or failure ratio (percentage) of LBT measured by the cell on the channel;
An average sending duration after successful LBT measured by the cell on the channel;
Available or unavailable physical resources measured by the cell on the channel;
A proportion of the available or unavailable physical resources to all physical resources measured by the cell on the channel;
A threshold of the RSSI;
A threshold of the CO;
A threshold of the number of LBT failures;
A threshold of the success ratio (percentage) or failure ratio (percentage) of LBT;
A threshold of the average sending duration after LBT success;
An ED threshold;
A maximum ED threshold;
An ED threshold offset;
A flag indicating whether there is another access technology that uses the same spectrum resource.

The result measured by the cell on the channel, such as the RSSI or the CO, can be used by Node 3 to judge the load situation of the unlicensed spectrum of the cell and/or the channel of the cell. Threshold related information refers to the threshold of the result measured by Node 3 on the channel of the cell, which can be used by Node 3 to judge whether the channel of the cell is suitable for providing services for Node 3. The ED threshold related information is used to generate measurement result on the Node 3 side.

Node 3 can select the appropriate cell to connect according to the above information.

Another method for self-configuration and self-optimization includes the following steps.

When the UE is in a handover, it can record information related to the quality of service. The information includes, but is not limited to, at least one of the following information:
An interval between the time of the last service data packet (for example, SDAP data packet) received on the connection of the source access node and the time of the first service data packet received on the connection of the target access node;
A number of lost packets and/or a ratio of lost packets of service data packets in a period;
An average delay of service data packets in a period;
An average jitter of service data packets in a period;
A starting time, and/or an ending time, and/or a length of time of the period.

The period may also be from the starting time of the handover to the ending time of the handover.

The UE may use the report information between the UE and the access node to report the information related to the quality of service to the access node. The report information may be a Successful Handover report or failure information (FailureInformation).

Node 1 and Node 2 may be different access nodes, such as different gNBs or different eNBs.

The inter-node interface may be an Xn interface or an X2 interface.

When the inter-node interface is an Xn interface, the inter-node interface message includes, but is not limited to, at least one of the following messages: HANDOVER REQUEST, HANDOVER REQUEST ACKNOWLEDGE, HANDOVER PREPARATION FAILURE, and a newly defined Xn message.

When the inter-node interface is an X2 interface, the inter-node interface message includes, but is not limited to, at least one of the following messages: HANDOVER REQUEST, HANDOVER REQUEST ACKNOWLEDGE, HANDOVER PREPARATION FAILURE, and a newly defined X2 message.

The access node can make self-configuration and self-optimization according to the information related to the quality of service, for example, selecting a more suitable target cell under similar circumstances to improve the user experience.

### Problem 8:

When the UE is configured as a dual connectivity, which cell is the primary secondary cell (PSCell) of the UE is decided by the secondary node (SN). When the master node (MN) configures the secondary node for the UE, the MN can generate a piece of information related to the wireless configuration of the secondary cell group, such as CG-ConfigInfo. Similarly, in the procedure of SN change initiated by the SN, the source SN may generate a piece of information related to the wireless configuration of the secondary cell group, such as CG-Config. The information related to the wireless configuration of the secondary cell group may include measurement information of cells on the target SN, and the target SN may decide which cell to be selected as the PSCell of the UE according to the information. However, in the existing mechanism, the measurement information does not include the measurement information of the unlicensed spectrum. In this way, in the deployment scenario of the unlicensed spectrum, the target SN cannot select the PSCell of the UE according to the measurement information of the unlicensed spectrum. The result may be that the target SN has selected an inappropriate PSCell, which increases the possibility of failure, such as LBT failure, and affects the user experience.

Another method for self-configuration and self-optimization includes the following steps.

Node 1 can send a piece of measurement report information to Node 2 through an inter-node interface message, and the measurement report information includes information as described in step 601. This can be achieved by two methods.

Method 1: The measurement report information is included in container information included in the inter-node interface message, for example, the container information may include one or more pieces of RRC information such as CG-ConfigInfo or CG-Config, and the RRC information may include measurement result information, which may be MeasResult2NR and/or MeasResultNR, and the measurement result information may include the measurement report information.

Method 2: The measurement report information is included by the inter-node interface message, instead of being included by a piece of container information.

Node 1 and Node 2 may be different access nodes, such as different gNBs or different eNBs, may be different units belonging to an access node, such as a gNB-DU and a gNB-CU, may be an access node and a core network node, such as a gNB and an AMF, or an eNB and a MME, may be a secondary node and a master node in a dual-connectivity or multi-connectivity scenario, or may be different units belonging to one or more access nodes, such as different gNB-DUs.

The inter-node interface can be an Xn interface, an X2 interface, an F1 interface, an Ng interface, or an S1 interface. The inter-node interface may also be an interface between two gNB-DUs.

When the inter-node interface is an Xn interface, the inter-node interface message includes, but is not limited to, at least one of the following messages: NG-RAN NODE CONFIGURATION UPDATE, NG-RAN NODE CONFIGURATION UPDATE ACKNOWLEDGE, CELL ACTIVATION REQUEST, CELL ACTIVATION RESPONSE, S-NODE ADDITION REQUEST, S-NODE ADDITION REQUEST ACKNOWLEDGE, S-NODE MODIFICATION REQUEST, S-NODE MODIFICATION REQUEST ACKNOWLEDGE, S-NODE MODIFICATION REQUIRED, S-NODE MODIFICATION CONFIRM, S-NODE CHANGE REQUIRED, S-NODE CHANGE CONFIRM, ACCESS AND MOBILITY INDICATION, and a newly defined Xn message.

When the inter-node interface is an X2 interface, the inter-node interface message includes, but is not limited to, at least one of the following messages: ENB CONFIGURATION UPDATE, ENB CONFIGURATION UPDATE ACKNOWLEDGE, CELL ACTIVATION REQUEST, CELL ACTIVATION RESPONSE, EN-DC CONFIGURATION UPDATE, EN-DC CONFIGURATION UPDATE ACKNOWLEDGE, EN-DC CELL ACTIVATION REQUEST, EN-DC CELL ACTIVATION RESPONSE, EN-DC CONFIGURATION TRANSFER, SGNB ADDITION REQUEST, SGNB ADDITION REQUEST ACKNOWLEDGE, SGNB MODIFICATION REQUEST, SGNB MODIFICATION REQUEST ACKNOWLEDGE, SGNB MODIFICATION REQUIRED, SGNB MODIFICATION CONFIRM, SGNB CHANGE REQUIRED, SGNB CHANGE CONFIRM, SGNB ADDITION REQUEST, SENB ADDITION REQUEST ACKNOWLEDGE, SENB MODIFICATION REQUEST, SENB MODIFICATION REQUEST ACKNOWLEDGE, SENB MODIFICATION REQUIRED, SENB MODIFICATION CONFIRM, and a newly defined X2 message.

When the inter-node interface is an F1 interface, the inter-node interface message includes, but is not limited to, at least one of the following messages: GNB-DU CONFIGURATION UPDATE, GNB-DU CONFIGURATION UPDATE ACKNOWLEDGE, GNB-CU CONFIGURATION UPDATE, GNB-CU CONFIGURATION UPDATE ACKNOWLEDGE, ACCESS AND MOBILITY INDICATION, and a newly defined F1 message.

When the inter-node interface is an Ng interface, the inter-node interface message includes, but is not limited to, at least one of the following messages: RAN CONFIGURATION UPDATE, RAN CONFIGURATION UPDATE ACKNOWLEDGE, AMF CONFIGURATION UPDATE, AMF CONFIGURATION UPDATE ACKNOWLEDGE, UPLINK RAN CONFIGURATION TRANSFER, DOWNLINK RAN CONFIGURATION TRANSFER, and a newly defined Ng message.

When the inter-node interface is an S1 interface, the inter-node interface message includes, but is not limited to, at least one of the following messages: ENB CONFIGURATION UPDATE, ENB CONFIGURATION UPDATE ACKNOWLEDGE, MME CONFIGURATION UPDATE, MME CONFIGURATION UPDATE ACKNOWLEDGE, eNB DIRECT INFORMATION TRANSFER, MME DIRECT INFORMATION TRANSFER, eNB CONFIGURATION TRANSFER, MME CONFIGURATION TRANSFER, and a newly defined S1 message.

When the inter-node interface is an interface between two gNB-DUs, the inter-node interface message may include, for example, but is not limited to, at least one of the following messages: a message related to setting or resetting the interface, and a message related to node configuration update.

Node 2 can perform self-configuration or self-optimization according to the received information. For example, Node 2, as the target SN, selects an appropriate PSCell according to the measurement report information. For example, a cell with a lower measurement result, such as the RSSI or the CO, of the channel which belongs to the cell is more suitable to be selected as the PSCell.

Exemplary embodiments of the present disclosure are further described below with reference to the accompanying drawings.

The text and drawings are provided as examples only to help understand the present disclosure. They should not be interpreted as limiting the scope of the disclosure in any way. Although certain embodiments and examples have been provided, based on the content disclosed herein, it will be obvious to those skilled in the art that changes may be made to the illustrated embodiments and examples without departing from the scope of the disclosure.

The application provides a method for self-configuring and self-optimizing. In order to make the purpose, technical scheme and advantages of the application clearer, the application will be further described in detail with reference to the attached drawings and examples. A detailed description of the steps unrelated to this application is omitted here.

### Embodiment 1

Embodiment 1 describes a situation where Node 1 sends channel information of one or more cells to Node 2 in a wireless communication system.

Node 1 and Node 2 may be different access nodes, such as different gNBs or different eNBs, may be different units belonging to an access node, such as a gNB-DU and a gNB-CU, may be an access node and a core network node, such as a gNB and an AMF, or an eNB and a MME, may be a secondary node and a master node in a dual-connectivity or multi-connectivity scenario, or may be different units belonging to one or more access nodes, such as different gNB-DUs.

FIG. 3 is a schematic diagram of embodiment 1, which includes the following steps.

Step 301: Node 1 sends Message 1 to Node 2. Message 1 carries the channel information on one or more cells. The channel information may include configuration information on one or more channels. The configuration information of the channel includes, but is not limited to, at least one of the following information:
A channel ID;
A center frequency;
A bandwidth;
A starting frequency;
An ending frequency;
A flag indicating whether the channel is used for the initial random access;
An ED threshold;
A maximum ED threshold;
An ED threshold offset;
A flag indicating whether there is another access technology that uses the same spectrum resource.

The ED threshold, and/or the maximum ED threshold, and/or the ED threshold offset, and/or the flag indicating whether there is another access technology that uses the same spectrum resource can also be separate configuration information for all or part of the channels.

The frequency-related parameters and bandwidth are used to identify a channel. The ED threshold related parameters are used to generate the measurement result of the channel, such as the RSSI or the CO. The flag indicating whether the channel is used for the initial random access is used to avoid using the same channel used for the initial random access between adjacent nodes, thereby reducing the possibility of an initial random access failure, such as the initial random access failure caused by lbt-failure.

### Embodiment 2

Embodiment 2 describes a situation where Node 1 instructs Node 2 to configure parameters for a channel on a cell in a wireless communication system.

Node 1 and Node 2 may be different access nodes, such as different gNBs or different eNBs, may be different units belonging to an access node, such as a gNB-CU and a gNB-DU, may be an access node and a core network node, such as a gNB and an AMF, or an eNB and a MME, may be a secondary node and a master node in a dual-connectivity or multi-connectivity scenario, or may be different units belonging to one or more access nodes, such as different gNB-DUs.

FIG. 4 is a schematic diagram of embodiment 2, which includes the following steps.

Step 401: Node 1 sends Message 1 to Node 2. Node 1 and Node 2 can be a UE and an access node, and Message 1 carries a piece of indication information. The indication information includes, but is not limited to, at least one of the following information:
Information on one or more cells of which configuration needs to be changed;
Wireless connection related report generated by the UE.

The report can be a CEF report, an RA report, a Successful Handover report, an RLF report, a measurement report or other reports related to wireless connection.

The information on the cell of which configuration needs to be changed includes, but is not limited to, at least one of the following information:
A Cell identity;
Information on one or more channels of which configuration needs to be changed;
A flag indicating that the channel used for the initial random access needs to be changed.

The cell identity may be a Cell Global ID (CGI) and/or an NR Physical Cell ID (PCI). The CGI can be a NR CGI or an E-UTRA CGI.

The information on the channel of which configuration needs to be changed includes, but is not limited to, at least one of the following information:
At least one piece of information of configuration information of the channel, such as a channel ID;
A flag indicating whether the channel is used for the initial random access;
A transmit power;
A maximum transmit power;
A flag indicating whether to enable uplink and downlink shared channel occupation (COT sharing);
A number of time slots used for the uplink and downlink shared channel occupation;
A position of time slots used for the uplink and downlink shared channel occupation;
An ED threshold used for the uplink and downlink shared channel occupation;
A channel access priority used for the uplink and downlink shared channel occupation;
A detection duration used to detect consecutive LBT failures;
A maximum number for detecting consecutive LBT failures.

The flag indicating that the channel used for the initial random access needs to be changed can be used to inform Node 2 to change the channel used for the initial random access. Node 2 can select an appropriate channel as a new channel used for the initial random access by itself.

Step 402: Node 2 can send Message 2 to Node 1. Message 2 includes, but is not limited to, at least one of the following information:
Information on one or more cells of which configuration is successful;
Information on one or more cells of which configuration is failed;
At least one piece of information of configuration information of a channel used for the initial random access, such as a channel ID.

The information on the cell of which configuration is successful includes, but is not limited to, at least one of the following information:
A cell identity;
Information on one or more channels of which configuration is successful;
Information on one or more channels of which configuration is failed.

The information on the channel of which configuration is successful includes, but is not limited to, at least one of the following information:
At least one piece of information of the configuration information of the channel, such as a channel ID.

The information on the channel of which configuration is failed includes, but is not limited to, at least one of the following information:
At least one piece of information of the configuration information of the channel, such as a channel ID;
At least one piece of information of the updated information on the channel of which configuration needs to be changed;
A cause.

The information on the cell of which configuration is failed includes, but is not limited to, at least one of the following information:

A cell identity.

Node 2 can analyze the wireless connection related report received in step 401. For example, the spectrum related parameters can identify the channel used by the UE when generating the wireless connection related report, the RSSI, the CO and the LBT related measurement result can be used to reflect the busy and idle states of the channel, and the ED threshold related parameters and/or detecting consecutive LBT failures can be used to generate the measurement result.

For at least one piece of information of the information on the channel of which configuration needs to be changed, Node 2 can configure different values or generate different proposed values according to the analysis result. For example, a different channel is selected for the initial random access, or which channel to be used for the initial random access is proposed.

The configured value or the generated proposed value may be included by the at least one piece of information of the updated information on the channel of which configuration needs to be changed.

If the flag indicating that the channel used for the initial random access needs to be changed is set in the previous step, Node 2 may select a channel as a new channel used for the initial random access. The information on the new channel is included by the at least one piece of information of the configuration information of the channel used for the initial random access.

Through the procedure described above, Node 1 can indicate the parameters configured for the channel to Node 2, such as which channel's resources are configured for the initial random access. Node 2 can configure according to the indication of Node 1, or can decide the parameters configured for the channel by itself, and/or generate the proposed values of the parameters configured for the channel. In this way, poor parameters configured between different nodes can be avoided, thus eliminating the resulting problems, such as LBT failures.

### Embodiment 3

Embodiment 3 describes a situation where Node 1 requests Node 2 to report load information of an unlicensed spectrum of one or more cells in a wireless communication system.

Node 1 and Node 2 may be different access nodes, such as different gNBs or different eNBs, may be different units belonging to an access node, such as a gNB-CU and a gNB-DU, may be an access node and a core network node, such as a gNB and an AMF, or an eNB and a MME, may be a secondary node and a master node in a dual-connectivity or multi-connectivity scenario, or may be different units belonging to one or more access nodes, such as different gNB-DUs.

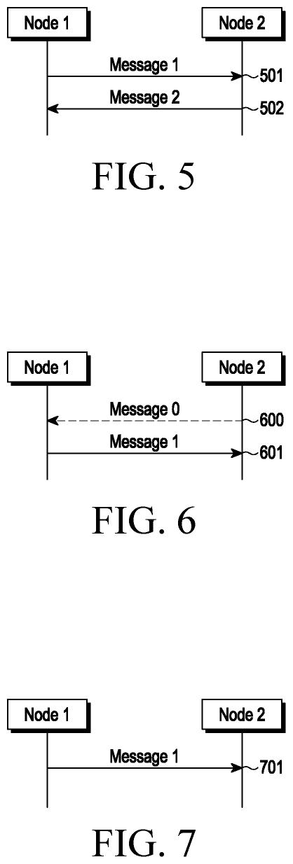

FIG. 5 is a schematic diagram of embodiment 3, which includes the following steps.

Step 501: Node 1 sends Message 1 to Node 2. Message 1 carries a piece of request information which requires Node 2 to report the load information of the unlicensed spectrum of one or more cells. The request information includes, but is not limited to, at least one of the following information:
A Cell identity;
Configuration information of load information of a channel used by one or more beams;
Configuration information of load information of a channel used by one or more slices;
Configuration information of load information of a channel used by one or more Public Land Mobile Networks (PLMNs);
Configuration information of load information of a channel used by one or more Non-Public Networks (NPNs);
Configuration information of load information of a channel.

The configuration information of the load information of the channel used by the beam includes at least one of the following information:

An identification of the beam, such as a SSB index;

Configuration information of load information of the channel.

The configuration information of the load information of the channel used by the slice includes at least one of the following information:
An identification of the slice, such as a S-NSSAI;
Configuration information of load information of the channel.

The configuration information of the load information of the channel used by the PLMN includes at least one of the following information:
A PLMN ID;
Configuration information of load information of the channel.

The configuration information of the load information of the channel used by the NPN includes at least one of the following information:
An identification of the NPN, such as a NID or a CAG ID;
A PLMN identification ID;
Configuration information of load information of the channel.

The configuration information of the load information of the channel includes, but is not limited to, at least one of the following information:
At least one piece of information of the configuration information of the channel, such as a channel ID;
A measurement interval length;
A flag indicating whether a measurement is periodic;
A measurement period length.

Step 502: Node 2 sends Message 2 to Node 1. Message 2 carries the requested load information of the unlicensed spectrum.

The load information of the unlicensed spectrum includes one or more of the following information:
A cell identity;
Load information of a channel used by one or more beams;
Load information of a channel used by one or more slices;
Load information of a channel used by one or more Public Land Mobile Networks (PLMNs);
Load information of a channel used by one or more Non-Public Networks (NPNs);
Load information of a channel.

The load information of the channel used by the beam includes at least one of the following information:
An identification of a beam, such as a SSB index;
Load information of the channel.

The load information of channels used by the slice includes at least one of the following information:
An identification of the slice, such as a S-NSSAI;
Load information of the channel.

The load information of the channel used by the PLMN includes at least one of the following information:
A PLMN identification ID;
Load information of the channel.

The load information of the channel used by the NPN includes at least one of the following information:
An identification of the NPN, such as a NID or a CAG ID;
A PLMN identification ID;
Load information of the channel.

The load information of the channel includes, but is not limited to, at least one of the following information:
At least one piece of information of the configuration information of the channel, such as a channel ID;
A RSSI (Received Signal Strength Indicator);
A CO (channel occupancy ratio/percentage);
A number of LBT failures;
A success ratio (percentage) or failure ratio (percentage) of LBT;
An average sending duration after successful LBT;
A transmit power;
A maximum transmit power;
A flag indicating whether to enable uplink and downlink shared channel occupation (COT sharing);
A number of time slots used for the uplink and downlink shared channel occupation;
A position of time slots used for the uplink and downlink shared channel occupation;
An ED threshold used for the uplink and downlink shared channel occupation;
A channel access priority used for the uplink and downlink shared channel occupation;
A number of consecutive LBT failures;
A detection duration used to detect consecutive LBT failures;
A maximum number for detecting consecutive LBT failures;
Available or unavailable physical resources;
A proportion of the available or unavailable physical resources to all physical resources.

The CO can be one or more of the following information:
A CO indicating that the channel is occupied by other nodes;
A CO indicating that the channel is occupied by the present node;
A CO indicating that a total of the channel occupied by other nodes and the present node.

The parameters related to detecting consecutive LBT failures are used to decide whether consecutive LBT failures occurs, and the parameters related to the uplink and downlink shared channel occupation and/or the number of consecutive LBT failures can be used to evaluate the state of the corresponding channel, such as the busy and idle states of the channel, which can be used for self-configuration and self-optimization, such as deciding the strategy of load balancing.

The load information of the channel can reflect the load state of a channel. For example, the RSSI is low, or the CO is low, or the number of LBT failures is few, or the LBT success ratio (percentage) is high or the failure ratio (percentage) is low, which indicates that the load of this channel is light and the channel can accept more loads, such as more UEs.

The load information may include the measurement result of Node 2, and may also include measurement result of other nodes received by Node 2.

Node 2 can also actively send the load information of the unlicensed spectrum to Node 1.

### Embodiment 4

Embodiment 4 describes a situation where Node 1 sends a wireless connection related report to Node 2 in a wireless communication system.

Node 1 and Node 2 may be a UE and an access node.

FIG. 6 is a schematic diagram of embodiment 4, which includes the following steps.

Step 600: Node 2 sends Message 0 to Node 1. Message 0 may carry a piece of configuration information, which may include at least one of the following information:
A channel ID;
A center frequency;
A bandwidth;
A starting frequency;
An ending frequency;
A flag indicating to perform the measurement of the number of LBT failures;
A flag indicating to perform the measurement of the LBT success/failure ratio (percentage);
A flag indicating to perform the measurement of the average LBT successful sending time;
A flag indicating to perform the measurement of the available or unavailable physical resources;
A flag indicating to perform the measurement of the proportion of available or unavailable physical resources to all physical resources.

Step 600 is not necessary.

Step 601: Node 1 sends Message 1 to Node 2. Message 1 carries a wireless connection related report.

The report may be a CEF report, an RA report, a Successful Handover report, an RLF report, a measurement report, secondary node failure information (SCGFailureInformation), or other reports related to wireless connection.

The report includes, but is not limited to, at least one of the following information:
A center frequency of the spectrum used for the random access;
A bandwidth of the spectrum used for the random access;
A starting frequency of the spectrum used for the random access;
An ending frequency of the spectrum used for the random access;
A center frequency of the measured spectrum;
A bandwidth of the measured spectrum;
A starting frequency of the measured spectrum;
An ending frequency of the measured spectrum;
A RSSI;
A CO;
A number of LBT failures;
A success ratio (percentage) or failure ratio (percentage) of LBT;
An average sending duration after successful LBT;
An ED threshold;
A maximum ED threshold;
An ED threshold offset;
Available or unavailable physical resources;
A proportion of the available or unavailable physical resources to all physical resources;
A flag indicating whether there is another access technology that uses the same spectrum resource;
A channel access priority (ChannelAccessPriority);
A cause, such as lbt-failure (listen before talk failure);
A center frequency of a spectrum used for connection with a source access node;
A bandwidth of the spectrum used for connection with the source access node;
A starting frequency of the spectrum used for connection with the source access node;
An ending frequency of the spectrum used for connection with the source access node;
A RSSI for the connection with the source access node;
A CO for the connection with the source access node;
A number of LBT failures for the connection with the source access node;
A success ratio (percentage) or failure ratio (percentage) of LBT for the connection with the source access node;
An average sending duration after successful LBT for the connection with the source access node;
An ED threshold for the connection with the source access node;
A maximum ED threshold for the connection with the source access node;
An ED threshold offset for the connection with the source access node;
A flag, configured by the source access node, indicating whether there is another access technology that uses the same spectrum resource;
A channel access priority (channelAccessPriority) for the connection with the source access node;
A center frequency of a spectrum used for connection with a target access node;
A bandwidth of the spectrum used for connection with the target access node;
A starting frequency of the spectrum used for connection with the target access node;
An ending frequency of the spectrum used for connection with the target access node;
A RSSI for the connection with the target access node;
A CO for the connection with the target access node;
A number of LBT failures for the connection with the target access node;
A success ratio (percentage) or failure ratio (percentage) of LBT for the connection with the target access node;
An average sending duration after successful LBT for the connection with the target access node;
An ED threshold for the connection with the target access node;
A maximum ED threshold for the connection with the target access node;
An ED threshold offset for the connection with the target access node;
A flag, configured by the target access node, indicating whether there is another access technology that uses the same spectrum resource;
A channel access priority (channelAccessPriority) for the connection with the target access node;
A flag indicating whether to enable uplink and downlink shared channel occupation (COT sharing);
A number of time slots used for the uplink and downlink shared channel occupation;
A position of time slots used for the uplink and downlink shared channel occupation;
An ED threshold used for the uplink and downlink shared channel occupation;
A channel access priority used for the uplink and downlink shared channel occupation;
A number of consecutive LBT failures;
A detection duration used to detect consecutive LBT failures;
A maximum number for detecting consecutive LBT failures;
A cell identity;
An identification of the node where the cell is located;
A beam identification;
A slice identification;
A PLMN identification.

A spectrum related parameter can identify a channel, the RSSI, the CO and the LBT related measurement result can be used to reflect the busy and idle states of the current channel, and the ED threshold related parameters and/or detecting consecutive LBT failures are used to generate the measurement result.

The report can be sent to the access node where the random access occurs, the source access node of handover or the access node where RLF occurs, or the node initiating the establishment of a dual-connectivity or multi-connectivity or the node initiating the change of the dual-connectivity or multi-connectivity, or the access node initiating the measurement. The access node can use the report for self-configuration or self-optimization, for example, judging whether the currently used random access resources or other radio resources are appropriate according to these reports, or judging whether the selection mechanism of the target cell is appropriate or whether the resource configuration of the target cell for handover is appropriate according to these reports. After self-configuration or self-optimization, the access node prevents failures from occurring in the future and enhances the user experience.

### Embodiment 5

Embodiment 5 describes a situation where Node 1 sends MDT configuration information to Node 2 in a wireless communication system.

Node 1 and Node 2 may be different access nodes, such as different gNBs or different eNBs, may be different units belonging to an access node, such as a gNB-CU and a gNB-DU, may be a core network node and an access node, such as an AMF and a gNB, or a MME and an eNB, may be a secondary node and a master node in a dual-connectivity or multi-connectivity scenario.

FIG. 7 is a schematic diagram of embodiment 5, which includes the following steps.

Step 701: Node 1 sends Message 1 to node 2. Message 1 carries a piece of configuration information, and the configuration information can be MDT configuration information. The MDT configuration information includes, but is not limited to, at least one of the following information:
A category flag indicating MDT measurement for the unlicensed spectrum, such as measurement of a RSSI, or measurement of a CO, or measurement of number of LBT failures, or measurement of LBT success/failure ratio (percentage) event;
A f lag indicating the MDT measurement for the unlicensed spectrum on the UE side;
MDT measurement related information for the unlicensed spectrum on the UE side;
A flag indicating the MDT measurement for the unlicensed spectrum on the access node side;
MDT measurement related information for the unlicensed spectrum on the access node side.

The MDT measurement related information includes at least one of the following information:
A flag indicating whether it is a Immediate MDT measurement (Immediate MDT) or a logged MDT measurement (logged MDT);
A time interval recording the MDT measurement;
A length of time recording the MDT measurement;
Information on the unlicensed spectrum related to the measurement;
Measurement report related information.

The information on the unlicensed spectrum related to the measurement includes, but is not limited to, at least one of the following: a channel ID, a center frequency, a bandwidth, a starting frequency, an ending frequency and a channel access priority.

The measurement report related information includes at least one of the following information:
A flag indicating whether it is a timing report or an event-triggered report;
A time interval of the timing report;
A length of time of the timing report;
Parameters related to the measurement result required to be reported, including, but not limited to, at least one of the following: a RSSI, a CO, a number of LBT failures, a LBT success/failure ratio (percentage), available or unavailable physical resources, and a proportion of the available or unavailable physical resources to all physical resources;
A flag of an event triggering the report, such as a RSSI event, a CO event, the number of LBT failures, an event of LBT success/failure ratio (percentage), an event of the available or unavailable physical resources, and an event of the proportion of the available or unavailable physical resources to all physical resources. The event may be that the parameter related to the measurement result is lower than or exceeds a threshold;
A threshold of the RSSI that triggers reporting;
A duration that the RSSI exceeds the threshold;
A threshold of the RSSI that stops reporting;
A hysteresis parameter of the RSSI that triggers or stops reporting;
A threshold of the CO that triggers reporting;
A duration that the CO exceeds the threshold;
A threshold of the CO that stops reporting;
A hysteresis parameter of the CO that triggers or stops reporting;
A threshold of the number of LBT failures that triggers reporting;
A duration that the number of LBT failures exceeds the threshold;
A threshold of the number of LBT failures that stops reporting;
A hysteresis parameter of the number of LBT failures that triggers or stops reporting;
A threshold of the LBT success/failure ratio (percentage) that triggers reporting;
A duration that the LBT success/failure ratio (percentage) is lower than or exceeds the threshold;
A threshold of the LBT success/failure ratio (percentage) that stops reporting;
A hysteresis parameter of the LBT success/failure ratio (percentage) that triggers or stops reporting;
A threshold of the available or unavailable physical resources that triggers reporting;
A duration that the available or unavailable physical resources is lower than or exceeds the threshold;
A threshold of the available or unavailable physical resources that stops reporting;
A hysteresis parameter of the available or unavailable physical resources that triggers or stops reporting;
A threshold of the proportion of the available or unavailable physical resources to all physical resources that triggers reporting;
A duration that the proportion of the available or unavailable physical resources to all physical resources is lower than or exceeds the threshold;
A threshold of the proportion of the available or unavailable physical resources to all physical resources that stops reporting;
A hysteresis parameter of the proportion of the available or unavailable physical resources to all physical resources that triggers or stops reporting.

The threshold, and/or the duration, and/or the hysteresis parameter may have only one value for all events.

Node 2 generates a MDT measurement report according to the MDT configuration information. The MDT measurement report includes, but is not limited to, at least one of the following information:
A center frequency of the measured spectrum;
A bandwidth of the measured spectrum;
A starting frequency of the measured spectrum;
An ending frequency of the measured spectrum;
A RSSI;
A CO;
A number of LBT failures;
A success ratio (percentage) or failure ratio (percentage) of LBT;
An average sending duration after successful LBT;
A ED threshold;
A maximum ED threshold;
An ED threshold offset;
A flag indicating whether there is another access technology that uses the same spectrum resource;
A channel access priority;
A channel ID;
Available or unavailable physical resources;
A proportion of the available or unavailable physical resources to all physical resources;
A flag indicating that this measurement occurs on the UE side;
A flag indicating that this measurement occurs on the access node side;
A cell identity;
An identification of the node where the cell is located;
A beam identification;
A slice identification;
A PLMN identification.

Node 2 sends the MDT measurement report to the address designated by the operator by using the existing mechanism.

The operator can judge the current state of the network according to the MDT measurement reports and find possible problems. For example, the frequent occurrence of LBT failures on the access node side or the UE side may be caused by improper deployment of the position of the access node, so that targeted network optimization measures can be taken to finally solve the problems, improve the network performance and enhance the user experience.

### Embodiment 6

Embodiment 6 describes a situation where adjacent access nodes exchange configuration information of channels and select different channels for the initial random access according to a UE report in the 5G network.

CU1 and DU1 constitute Access Node 1, and CU2 and DU2 constitute Access Node 2. A cell of DU1 is a neighboring cell of a cell of DU2.

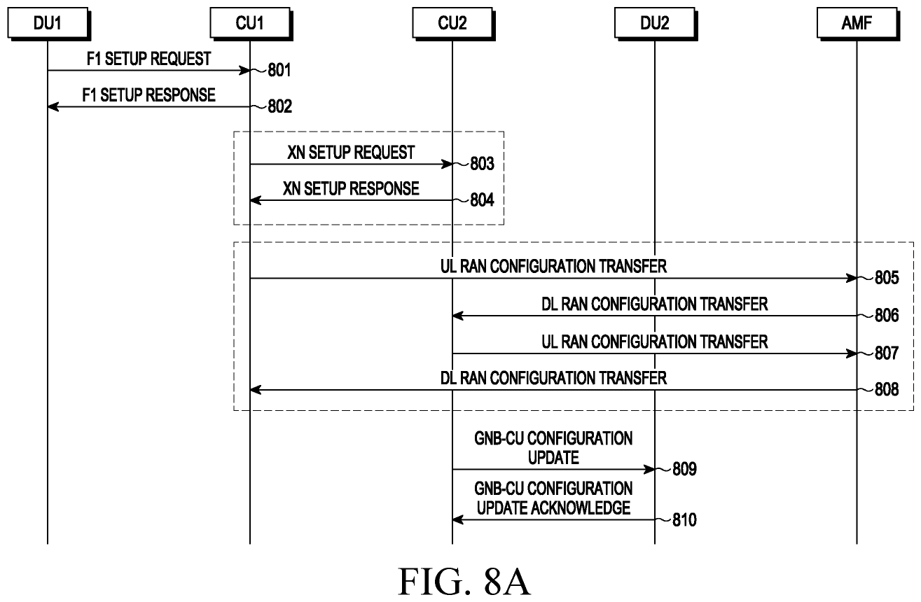

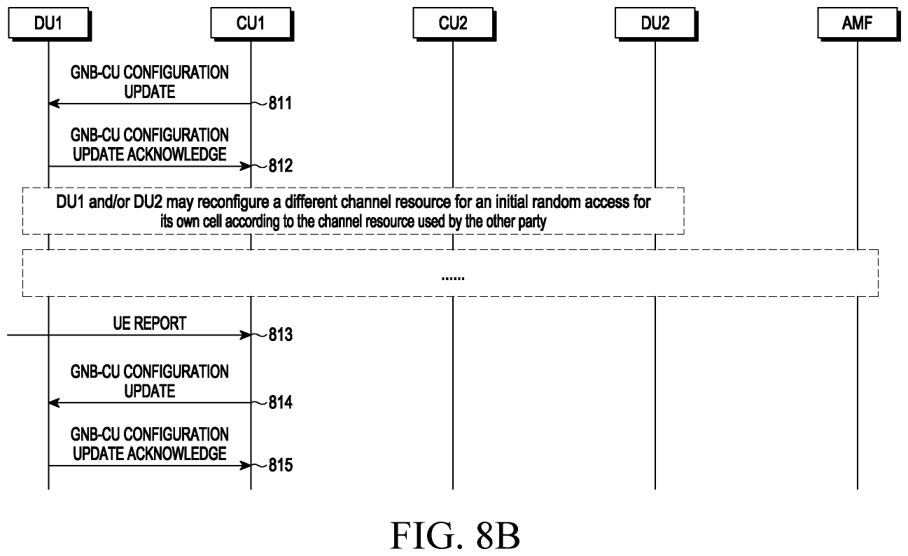

FIG. 8a and FIG. 8b are a schematic diagram of embodiment 6, which includes the following steps.

At step 801: DU1 sends F1 SETUP REQUEST to CU1.

The message carries channel information of one or more cells. The channel information may include configuration information of one or more channels. The configuration information of the channel includes, but is not limited to, at least one of the following information:
A channel ID;
A center frequency;
A bandwidth;
A starting frequency;
An ending frequency;
A flag indicating whether the channel is used for the initial random access;
An ED threshold;
A maximum ED threshold;
An ED threshold offset;
A flag indicating whether there is another access technology that uses the same spectrum resource.

After receiving the information, CU1 saves the received information, and then responds to this message as in step 802.

Access Node 1 decides to send the channel information of the cell to which it belongs to Access Node 2. There are two methods.

Method 1: An Xn interface is used, as in steps 803-804.

Step 803: If CU1 has not established an Xn connection with CU2, CU1 sends XN SETUP REQUEST to CU2. The message includes the channel information of the cell to which it belongs received in step 801.

After receiving the information, CU2 saves the received information, and then sends XN SETUP RESPONSE to CU1 as in step 804. The message includes the channel information of the cell to which it belongs.

If CU1 has established the Xn connection with CU2, CU1 sends NG-RAN NODE CONFIGURATION UPDATE to CU2, and the message includes the channel information of the cell to which it belongs received in step 801.

After receiving the information, CU2 saves the received information, and then sends NG-RAN NODE CONFIGURATION UPDATE ACKNOWLEDGE to CU1. The message includes the channel information of the cell to which it belongs.

Method 2: An Ng interface is used, as described in steps 805-808.

Steps 805-806: CU1 sends UPLINK RAN CONFIGURATION TRANSFER to the AMF, and the message includes the channel information of the cell to which it belongs received in step 801. The AMF sends DOWNLINK RAN CONFIGURATION TRANSFER to CU2, and the message includes the channel information of the cell received in step 805.

Steps 807-808: After receiving the information, CU2 saves the received information, and then the AMF sends UPLINK RAN CONFIGURATION TRANSFER, and the message includes the channel information of the cell to which it belongs. The AMF sends DOWNLINK RAN CONFIGURATION TRANSFER to CU1, and the message includes the channel information of the cell received in step 807.

Through the method, Access Node 1 and Access Node 2 exchange and save the channel information of cells to which it belongs respectively for future use, such as generating a strategy of load balancing or selecting a target cell for UE handover.

Steps 809-810: CU2 sends GNB-CU CONFIGURATION UPDATE to DU2, and the message includes the channel information of the cell to which it belongs received from CU1.

DU2 saves the received information and then responds to this message as in step 804.

Steps 811-812: Similar to steps 809-810, CU1 sends to DU1 the channel information of the cell to which it belongs received from CU2.

In this way, DU1 and DU2 exchange and save the channel information of cells to which it belongs respectively for future use. For example, DU1 or DU2 can select a different channel used for the initial random access.

Step 813: the UE may generate a report related to the random access, such as a CEF report or an RA report, in the procedure of the initial random access initiated to the cell of DU1.

The report may include at least one of the following information:
A center frequency of the spectrum used for the random access;
A bandwidth of the spectrum used for the random access;
A starting frequency of the spectrum used for the random access;
An ending frequency of the spectrum used for the random access;
A RSSI;
A CO;
A number of LBT failures;
A success ratio (percentage) or failure ratio (percentage) of LBT;
An average sending duration after successful LBT;
An ED threshold;
A maximum ED threshold;
An ED threshold offset;
A flag indicating whether there is another access technology that uses the same spectrum resource;
A channel access priority;
A Cause, such as lbt-failure (listen before talk failure).

The spectrum related parameter can identify a channel, the RSSI, the CO and the LBT related measurement result can be used to reflect the busy and idle states of the current channel, and the ED threshold related parameter is used to generate the measurement result.

After receiving the report, CU1 can judge whether the channel currently used by the cell for the initial random access is appropriate according to the information carried in the report, for example, it can know the channel used by the random access according to the spectrum related parameters; according to the measurement result related to the RSSI, the CO and the LBT, it can judge the state of the channel on the UE side and whether the UE is suitable for performing the random access on the channel; according to the ED threshold related parameters, it can judge whether the measurement result related to the RSSI, the CO and the LBT are reasonable and whether it is necessary to adjust the ED threshold related parameters; according to the flag indicating whether there is another access technology that uses the same spectrum resource, it can judge whether there is another access technology that uses the same spectrum resource when the random access occurs, thus causing interference to the random access procedure.

Step 814: CU1 judges that the channel currently used by the cell for the initial random access is not the best choice according to the report. CU1 may decide to modify the configuration information of channels of the cell.

CU1 sends GNB-CU CONFIGURATION UPDATE to DU1, and the message may carry a piece of indication information. The indication information includes, but is not limited to, at least one of the following information:

Information on one or more cells of which configuration needs to be changed;

Wireless connection related report generated by the UE.

The report can be a CEF report, an RA report, a Successful Handover report, an RLF report, a measurement report or other reports related to wireless connection.

The information on the cell of which configuration needs to be changed includes, but is not limited to, at least one of the following information:
A Cell identity;
Information on one or more channels of which configuration needs to be changed;
A flag indicating that the distributed unit needs to be changed for the initial random access.

The cell identity may be a Cell Global ID (CGI) and/or an NR Physical Cell ID (PCI). The CGI can be a NR CGI or an E-UTRA CGI.

The information on the channel of which configuration needs to be changed includes, but is not limited to, at least one of the following information:
At least one piece of information of the configuration information of the channel, such as a channel ID;
A flag indicating whether the channel is used for the initial random access;
A transmit power;
A maximum transmit power;
A flag indicating whether to enable uplink and downlink shared channel occupation (COT sharing);
A number of time slots used for the uplink and downlink shared channel occupation;
A position of time slots used for the uplink and downlink shared channel occupation;
An ED threshold used for the uplink and downlink shared channel occupation;
A channel access priority used for the uplink and downlink shared channel occupation;
A detection duration used to detect consecutive LBT failures;
A maximum number for detecting consecutive LBT failures.

Step 815: If the configuration is successful or part of the configuration is successful, DU1 may send GNB-CU CONFIGURATION UPDATE ACKNOWLEDGE to CU1, otherwise, it will send GNB-CU CONFIGURATION UPDATE FAILURE.

GNB-CU CONFIGURATION UPDATE ACKNOWLEDGE includes, but is not limited to, at least one of the following information:

Information on one or more cells of which configuration is successful;

Information on one or more cells of which configuration is failed.

The information on the cell of which configuration is successful includes, but is not limited to, at least one of the following information:
A Cell identity;
Information on one or more channels of which configuration is successful;
Information on one or more channels of which configuration is failed;
At least one piece of information of the configuration information of the channel used for the initial random access, such as a channel ID.

The information on the channel of which configuration is successful includes, but is not limited to, at least one of the following information:
At least one piece of information of the configuration information of the channel, such as a channel ID.

The information on the channel of which configuration is failed includes, but is not limited to, at least one of the following information:
At least one piece of information of the configuration information of the channel, such as a channel ID;
At least one piece of information of the updated information on the channel of which configuration needs to be changed;
A cause.

GNB-CU CONFIGURATION UPDATE FAILURE includes, but is not limited to, at least one of the following information:

Cell identities of one or more cells of which configuration is failed;

A cause.

DU2 can analyze the wireless connection related report received in the previous step, for example, spectrum related parameters can identify the channel used by the UE when generating the wireless connection related report, the RSSI, the CO and the LBT related measurement result can be used to reflect the busy and idle states of the channel, and the ED threshold related parameters and/or detecting consecutive LBT failures can be used to generate the measurement result.

For at least one piece of information of the information on the channel of which configuration needs to be changed, DU2 can configure different values or generate different proposed values according to the analysis results. For example, DU2 decides to change the channel of a cell for the initial random access according to the analysis results.

In this way, the configuration information of the channel used for the initial random access in GNB-CU CONFIGURATION UPDATE ACKNOWLEDGE includes at least one piece of information of the configuration information of the newly selected channel, such as a channel ID or a center frequency.

The wireless connection related report can also be sent separately using other F1 interface messages, such as ACCESS AND MOBILITY INDICATION or a newly defined F1 interface message.

Upon receiving the wireless connection related report, DU1 may modify the information on the channel of which configuration needs to be changed, for example, decide to change the channel of a cell for the initial random access. At this time, DU1 may send GNB-DU CONFIGURATION UPDATE to CU1, and the message includes at least one of the following information:
information on one or more cells of which configuration is updated;
At least one piece of information of the configuration information of the channel used for the initial random access, such as a channel ID.

The information on the cell of which configuration is updated includes, but is not limited to, at least one of the following information:
A Cell identity;
Information on one or more channels of which configuration is updated.

The information on the channel of which configuration is updated includes, but is not limited to, at least one of the following information:
At least one piece of information of the configuration information of the channel, such as a channel ID;
At least one piece of information of the updated information of the channel of which configuration needs to be changed.

CU1 saves the received information on the cell of which configuration is updated, and informs CU2 to update the information on the channel of the cell which CU1 belongs to through steps 803-804 or steps 805-808.

According to the procedure described in this embodiment, between the access nodes or the DUs, the channel information of the cells to which they belong is exchanged, and the information can be used, for example, to generate a strategy of load balancing. In addition, different access nodes and different DUs can avoid using the same channel used for the initial random access, thus avoiding interference between them and the resulting the random access failure, and enhancing the user experience.

### Embodiment 7

Embodiment 7 describes a situation where an access node requests another access node to report the load information of channels of one or more cells in a 5G network.

CU2 and DU2 constitute Access Node 2.

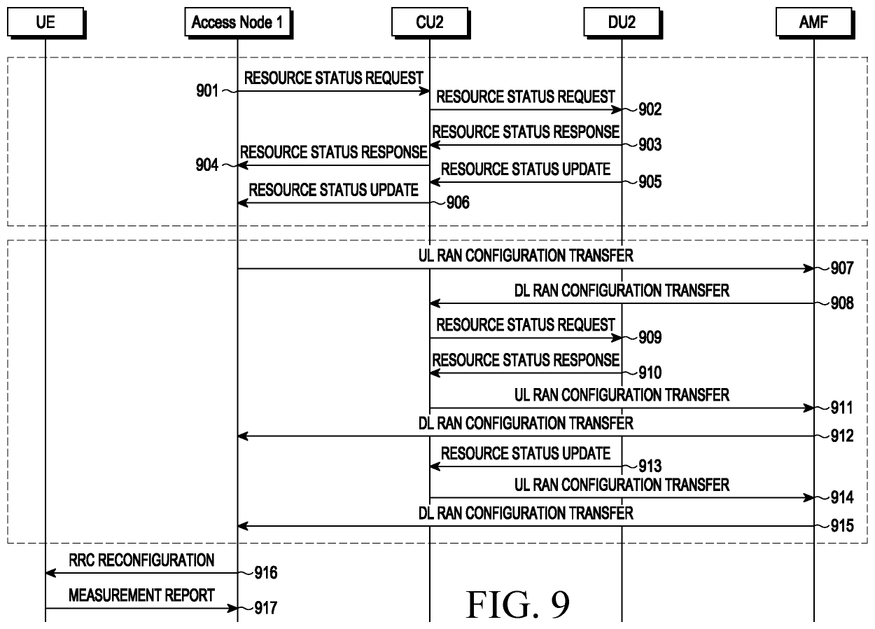

FIG. 9 is a schematic diagram of embodiment 7, which includes the following steps.

According to whether an Xn connection is established between two access nodes, there are two methods.

Method 1: an Xn interface is used, as in steps 901-906.

Step 901: Access Node 1 sends a RESOURCE STATUS REQUEST to CU2. The message carries a piece of request information, which requires CU2 to report the load information of unlicensed spectrums of one or more cells. The request information includes, but is not limited to, at least one of the following information:
A cell identity;
Configuration information of load information of a channel used by one or more beams;
Configuration information of load information of a channel used by one or more slices;
Configuration information of load information of a channel used by one or more Public Land Mobile Networks (PLMNs);
Configuration information of load information of a channel used by one or more Non-Public Networks (NPNs);
Configuration information of load information of a channel.

The configuration information of the load information of the channel used by the beam includes at least one of the following information:
An Identification of the beam, such as a SSB index;

Configuration information of load information of the channel.

The configuration information of the load information of the channel used by the slice includes at least one of the following information:
An identification of the slice, such as a S-NSSAI;
Configuration information of load information of the channel.

The configuration information of the load information of the channel used by the PLMN includes at least one of the following information:
A PLMN ID;
Configuration information of load information of the channel.

The configuration information of the load information of the channel used by the NPN includes at least one of the following information:
An identification of the NPN, such as a NID or a CAG ID;
A PLMN ID;
Configuration information of load information of the channel.

The configuration information of the load information of the channel includes, but is not limited to, at least one of the following information:
At least one piece of information of the configuration information of the channel, such as a channel ID;
A measurement interval length;
A flag indicating whether a measurement is periodic;
A Measurement period length.

Steps 902-903: CU2 saves the received request information. CU2 sends RESOURCE STATUS REQUEST to DU2. The message includes the request information carried in the previous step.

DU2 saves the received request information, and responds to this message as in step 903.

Step 904: CU2 sends RESOURCE STATUS RESPONSE to Access Node 1.

Step 905: DU2 begins periodic or aperiodic measurement on the load information of the unlicensed spectrum of the designated cell in accordance with the request of CU2, and sends RESOURCE STATUS UPDATE to CU2, and the message includes the requested load information of the unlicensed spectrum. The load information of the unlicensed spectrum includes one or more of the following information:
A cell identity;
Load information of a channel used by one or more beams;
Load information of a channel used by one or more slices;
Load information of a channel used by one or more Public Land Mobile Networks (PLMNs);
Load information of channels used by one or more Non-Public Networks (NPNs);
Load information of a channel.

The load information of the channel used by the beam includes at least one of the following information:
An identification of the beam, such as a SSB index;
Load information of the channel.

The load information of the channel used by the slice includes at least one of the following information:
An identification of the slice, such as a S-NSSAI;
Load information of the channel.

The load information of the channel used by the PLMN includes at least one of the following information:
A PLMN ID;
Load information of the channel.

The load information of the channel used by the NPN includes at least one of the following information:
An identification of the NPN, such as a NID or a CAG ID;
A PLMN ID;
Load information of the channel.

The load information of the channel includes, but is not limited to, at least one of the following information:
At least one piece of information of the configuration information of the channel, such as a channel ID;
A RSSI;
A CO;
A number of LBT failures;
A success ratio (percentage) or failure ratio (percentage) of LBT;
An average sending duration after successful LBT;
A transmit power;
A maximum transmit power;
A flag indicating whether to enable uplink and downlink shared channel occupation (COT sharing);
A number of time slots used for the uplink and downlink shared channel occupation;
A position of time slots used for the uplink and downlink shared channel occupation;
An ED threshold used for the uplink and downlink shared channel occupation;
A channel access priority used for the uplink and downlink shared channel occupation;
A number of consecutive LBT failures;
A detection duration used to detect consecutive LBT failures;
A maximum number for detecting consecutive LBT failures;
A proportion of available or unavailable physical resources to all physical resources.

The CO can be one or more of the following information:
A CO indicating that the channel is occupied by other nodes;
A CO indicating that the channel is occupied by the present node;
A CO indicating that a total of the channel occupied by other nodes and the present node.

Step 906: CU2 sends RESOURCE STATUS UPDATE to Access Node 1, and the message includes the requested load information of the unlicensed spectrum.

Method 2: an Ng interface is used, as in steps 907-915.

Steps 907-908: Access Node 1 sends UPLINK RAN CONFIGURATION TRANSFER to AMF, and the message carries a piece of request information, which requires Access Node 2 to report the load information of the unlicensed spectrums of one or more cells. The request information is the same as that described in step 901.

The AMF sends DOWNLINK RAN CONFIGURATION TRANSFER to CU2, and the message carries the request information received in the previous step.

Steps 909-910: They are the same as steps 902-903.

Steps 911-912: CU2 sends UPLINK RAN CONFIGURATION TRANSFER to the AMF, and the message carries the response information to the request information carried in step 908. The response message includes at least one of the following information:
Acceptance of the request;
Rejection of the request;
A Cause.

The AMF sends DOWNLINK RAN CONFIGURATION TRANSFER to Access Node 1, and the message carries the response information received in the previous step.

Step 913: It is the same as step 905.

Step 914-915: CU2 sends UPLINK RAN CONFIGURATION TRANSFER to the AMF, and the message carries the requested load information of the unlicensed spectrum.

The AMF sends DOWNLINK RAN CONFIGURATION TRANSFER to Access Node 1, and the message carries the requested load information received in the previous step.

In this way, Access Node 1 obtains the load information of the unlicensed spectrum of Access Node 2 through method 1 or method 2. Access Node 1 can judge the load state of Access Node 2 in the unlicensed spectrum according to the load information. For example, the parameter related to detecting consecutive LBT failures in the load information is used to decide whether consecutive LBT failures occur, and the parameter related to the uplink and downlink shared channel occupation and/or the number of consecutive LBT failures can be used to evaluate the state of the corresponding channel, such as the busy and idle states of the channel. The RSSI, the CO and/or the LBT related measurement result can reflect the load state of a channel. For example, the RSSI is low, the CO is low, the number of LBT failures is few, the LBT success ratio (percentage) is high, or the LBT failure ratio (percentage) is low, which means that the load of this channel is light and the channel can accept more loads, such as more UEs.

Steps 916-917: Access Node 1 configures the UE to perform unlicensed spectrum related measurement. Access Node 1 sends an RRC message RRCReconfiguration to the UE. The message includes the measurement configuration of the UE, and the measurement configuration may include at least one of the following information:
A center frequency of the channel;
A channel ID;
A bandwidth;
A starting frequency;
An ending frequency;
A flag indicating to perform the measurement of the number of LBT failures;
A flag indicating to perform the measurement of the LBT success/failure ratio (percentage);
A flag indicating to perform the measurement of the average LBT successful sending time.

The UE generates a measurement report according to the measurement configuration, and the measurement report may include at least one of the following information:
A RSSI;
A CO;
A number of LBT failures;
A LBT success/failure ratio (percentage);
An average LBT successful sending time;
A flag indicating whether to enable uplink and downlink shared channel occupation (COT sharing);
A number of time slots used for the uplink and downlink shared channel occupation;
A position of time slots used for the uplink and downlink shared channel occupation;
An ED threshold used for the uplink and downlink shared channel occupation;
A channel access priority used for the uplink and downlink shared channel occupation;
A number of consecutive LBT failures;
A detection duration used to detect consecutive LBT failures;
A maximum number for detecting consecutive LBT failures.

Access Node 1 can judge the load state of the UE in the unlicensed spectrum according to the measurement report (MeasurementReport) sent by the UE in step 917. For example, the parameter related to detecting consecutive LBT failures in the load information is used to decide whether consecutive LBT failures occur, and the parameter related to the uplink and downlink shared channel occupation and/or the number of consecutive LBT failures can be used to evaluate the state of the corresponding channel, such as the busy and idle states of the channel. The RSSI, the CO and/or the LBT related measurement result can reflect the load state of the channel. For example, the RSSI being low, the CO being low, the number of LBT failures being few, the LBT success ratio (percentage) being high or the LBT failure ratio (percentage) being low means that the load of this channel is light and the channel is suitable to be configured for the UE for use; otherwise, it should be considered to change the current configuration used by the UE or to hand the UE over to a suitable cell.

Access Node 1 can use the above information for self-configuration and self-optimization, such as changing the current configuration used by the UE, generating a strategy of load balancing, deciding to hand the UE over to another cell, and selecting an appropriate target cell for the UE, so that the UE can use an appropriate channel to transmit data, improving the user experience.

### Embodiment 8

Embodiment 8 describes a situation where a UE generates a handover related report and sends it to an access node after a handover in an unlicensed spectrum deployment scenario in a 5G network.

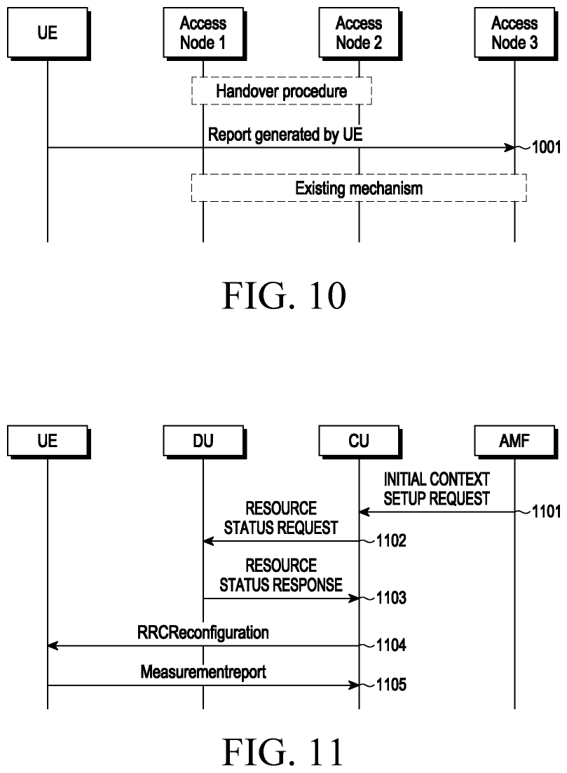

FIG. 10 is a schematic diagram of embodiment 8, which includes the following steps.

Access Node 1 hands the UE over to Access Node 2, and the UE can generate a handover related report in the handover procedure. For example, in a short time after the handover procedure is completed, a RLF occurs in the UE on Access Node 2, and the UE generates a RLF report. Or the handover is successful, and the UE generates a Successful Handover report.

Step 1001: The UE connects to Access Node 3. The UE sends the report to Access Node 3, and the report may include at least one of the following information:
A center frequency of a spectrum used for connection with a source access node;
A bandwidth of the spectrum used for connection with the source access node;
A starting frequency of the spectrum used for connection with the source access node;
An ending frequency of the spectrum used for connection with the source access node;
A RSSI for the connection with the source access node;
A CO for the connection with the source access node;
A number of LBT failures for the connection with the source access node;
A success ratio (percentage) or failure ratio (percentage) of LBT for the connection with the source access node;
An average sending duration after successful LBT for the connection with the source access node;
An ED threshold for the connection with the source access node;
A maximum ED threshold for the connection with the source access node;
An ED threshold offset for the connection with the source access node;
A flag, configured by the source access node, indicating whether there is another access technology that uses the same spectrum resource;
A channel access priority for the connection with the source access node;
A center frequency of a spectrum used for connection with a target access node;
A bandwidth of the spectrum used for connection with the target access node;
A starting frequency of the spectrum used for connection with the target access node;
An ending frequency of the spectrum used for connection with the target access node;
A RSSI for the connection with the target access node;
A CO for the connection with the target access node;
A number of LBT failures for the connection with the target access node;
A success ratio (percentage) or failure ratio (percentage) of LBT for the connection with the target access node;
An average sending duration after successful LBT for the connection with the target access node;
An ED threshold for the connection with the target access node;
A maximum ED threshold for the connection with the target access node;
An ED threshold offset for the connection with the target access node;
A flag, configured by the target access node, indicating whether there is another access technology that uses the same spectrum resource;
A channel access priority for the connection with the target access node;
A cause, such as lbt-failure (listen before talk failure).

According to the existing mechanism, the report is sent to Access Node 1.

Access Node 1 can judge whether the timing of initiating the handover is appropriate and whether the selection of the target cell is appropriate according to the information in the report, for example, it can know the channel used by the random access according to the spectrum related parameters; according to the measurement result related to the RSSI, the CO and the LBT, it can judge the state of the channel on the UE side and whether the channel is suitable for providing services for the UE; according to the ED threshold related parameters, it can judge whether the measurement results related to the RSSI, the CO and the LBT are reasonable and whether it is necessary to adjust the ED threshold related parameters; according to the flag indicating whether there is another access technology that uses the same spectrum resource, it can judge whether there is another access technology that uses the same spectrum resource when the UE connects to the access node, thus causing interference to the data transmission of the UE. Access Node 1 can judge whether the source access node is still suitable for providing services for the UE and whether the timing of the handover is appropriate according to the part related to the source access node in the above information, and judge whether the target node or the target cell is suitable according to the part related to the target access node in the above information.

The Access Node 1 can use the above information for self-configuration or self-optimization. For example, if the handover timing is improper or the target node or the target cell is improperly selected, the Access Node 1 can modify its own configuration to optimize the handover strategy, thus avoiding similar failures in the future and improving the user experience.

### Embodiment 9

Embodiment 9 describes a situation where MDT measurement is configured in a scenario of deployment of unlicensed spectrum in a 5G network.

FIG. 11 is a schematic diagram of embodiment 9, which includes the following steps.

Step 1101: In a registration procedure of the UE, the AMF sends an INITIAL CONTEXT SETUP REQUEST message to CU, and the message carries MDT configuration information. The MDT configuration information includes, but is not limited to, at least one of the following information:
A category flag indicating MDT measurement for the unlicensed spectrum, such as a RSSI measurement, or a CO measurement, or a measurement of the number of LBT failures, or a measurement of a LBT success/failure ratio (percentage) event;
A flag indicating the MDT measurement for the unlicensed spectrum on the UE side;
MDT measurement related information for the unlicensed spectrum is on the UE side;
A flag indicating the MDT measurement for the unlicensed spectrum is on the access node side;
MDT measurement related information for the unlicensed spectrum on the access node side.

The MDT measurement related information includes at least one of the following information:
A flag indicating whether the measurement is an Immediate MDT measurement (Immediate MDT) or a logged MDT measurement (logged MDT);
A time interval recording the MDT measurement;
A length of time recording the MDT measurement;
Information on the unlicensed spectrum related to the measurement;
Measurement report related information.

The measurement report related information includes at least one of the following information:
A flag indicating whether the report is a timing report or an event-triggered report;
A time interval of the timing report;
A length of time of the timing report;
Parameters related to the measurement results required to be reported, including, but not limited to, at least one of the following: a RSSI, a CO, a number of LBT failures, a LBT success/failure ratio (percentage), available or unavailable physical resources, and a proportion of the available or unavailable physical resources to all physical resources;
A flag of an event triggering the report, such as a RSSI event, a CO event, the number of LBT failures, an event of the LBT success/failure ratio (percentage), an event of the available or unavailable physical resources, and an event of the proportion of available or unavailable physical resources to all physical resources, and the event may be that the parameter related to the measurement result is lower than or exceeds a threshold;
A threshold of the RSSI that triggers reporting;
A duration that the RSSI exceeds the threshold;
A threshold of the RSSI that stops reporting;
A hysteresis parameter of the RSSI that triggers or stops reporting;
A threshold of the CO that triggers reporting;
A duration that the CO exceeds the threshold;
A threshold of the CO that stops reporting;
A hysteresis parameter of the CO that triggers or stops reporting;
A threshold of the number of LBT failures that triggers reporting;
A duration that the number of LBT failures exceeds the threshold;
A threshold of the number of LBT failures that stops reporting;
A hysteresis parameter of the number of LBT failures that triggers or stops reporting;
A threshold of the LBT success/failure ratio (percentage) that triggers reporting;
A duration that the LBT success/failure ratio (percentage) is lower than or exceeds the threshold;
A threshold of the LBT success/failure ratio (percentage) that stops reporting;
A hysteresis parameter of the LBT success/failure ratio (percentage) that triggers or stops reporting;
A threshold of the available or unavailable physical resources that triggers reporting;
A duration that the available or unavailable physical resources is lower than or exceeds the threshold;
A threshold of the available or unavailable physical resources that stops reporting;
A hysteresis parameter of the available or unavailable physical resources that triggers or stops reporting;
A threshold of the proportion of the available or unavailable physical resources to all physical resources that triggers reporting;
A duration that the proportion of the available or unavailable physical resources to all physical resources is lower than or exceeds the threshold;
A threshold of the proportion of the available or unavailable physical resources to all physical resources that stops reporting;
A hysteresis parameter of the proportion of the available or unavailable physical resources to all physical resources that triggers or stops reporting.

The threshold, and/or the duration, and/or the hysteresis parameter may have only one value for all events.

Steps 1102-1103: CU saves the received MDT configuration information.

If reporting the MDT measurement result on the access node side for the unlicensed spectrum is required in the MDT configuration information, CU requires DU to report the load information of the unlicensed spectrum. Steps 1102-1103 are similar to steps 902-903 in the previous embodiment.

Step 1104: DU begins periodic or aperiodic measurement on the load information of the designated unlicensed spectrum in accordance with the request of CU, and sends RESOURCE STATUS UPDATE to CU, where the message includes the requested load information of the unlicensed spectrum. Step 1104 is similar to step 905 in the previous embodiment.

Steps 1105-1106: If reporting the MDT measurement result on the UE side for the unlicensed spectrum is required in the MDT configuration information, CU sends RRC signaling configuration measurement to the UE. Steps 1105-1106 are similar to steps 916-917 in the previous embodiment.

CU generates a MDT measurement report according to the received information. The MDT measurement report includes, but is not limited to, at least one of the following information:
A center frequency of the measured spectrum;
A bandwidth of the measured spectrum;
A starting frequency of the measured spectrum;
An ending frequency of the measured spectrum;
A RSSI;
A CO;
A number of LBT failures;
A success ratio (percentage) or failure ratio (percentage) of LBT;
An average sending duration after successful LBT;
An ED threshold;
A maximum ED threshold;
An ED threshold offset;
A flag indicating whether there is another access technology that uses the same spectrum resource;
A channel access priority;
A channel ID;
Available or unavailable physical resources;
A proportion of the available or unavailable physical resources to all physical resources;
A flag indicating that this measurement occurs on the UE side;
A flag indicating that this measurement occurs on the access node side;
A cell identity;
An identification of the node where the cell is located;
A beam identification;
A slice identification;
A Public Land Mobile Network (PLMN) identification.

CU sends the MDT measurement report to the address designated by the operator according to the existing mechanism.

The MDT measurement report is used to judge the current state of the network to find possible problems in the network, such as wrong configuration parameters or inappropriate network deployment. According to the information, the operators can optimize their own network, improve the network performance, and ultimately enhance the user experience.

### Embodiment 10

Embodiment 10 describes a situation where a CHO or DAPS handover occurs in a scenario of deployment of unlicensed spectrum in a 5G network.

CU-CP1 and CU-UP1 belong to Access Node 1, and CU-CP2 and CU-UP2 belong to Access Node 2.

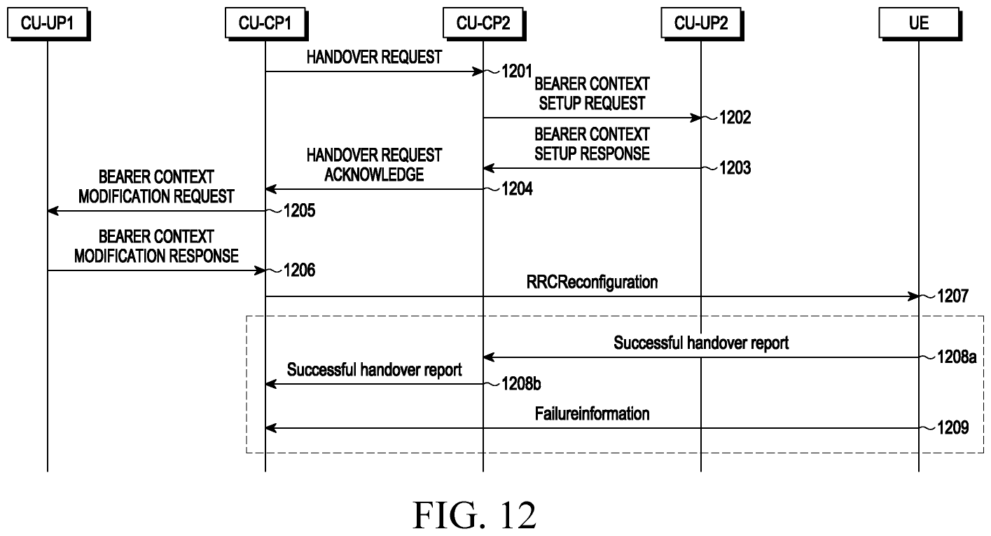

FIG. 12 is a schematic diagram of embodiment 10, which includes the following steps.

Step 1201: CU-CP1 sends HANDOVER REQUEST to CU-CP2. If the handover belongs to the CHO, the message should carry Conditional Handover Information Request information.

Step 1202: CU-CP2 sends an E1 interface message BEARER CONTEXT SETUP REQUEST to CU-UP2.

Step 1203: CU-UP2 sends BEARER CONTEXT SETUP RESPONSE to CU-CP2. If the handover belongs to the CHO, CU-UP2 judges whether the handover can accept forwarding data in advance according to its own state, such as load state. CU-UP2 may include at least one of the following information in the message:
A flag indicating whether forwarding data in advance is acceptable;
A maximum acceptable amount of the data forwarded in advance that needs to be cached.

Step 1204: CU-CP2 sends HANDOVER REQUEST ACKNOWLEDGE to CU-CP1, and the message includes the above information.

In addition, the CU-CP2 may include the load information of the unlicensed spectrum corresponding to the target cell in the message, where the load information may include the information defined in other parts of the present disclosure.

Steps 1205-1206: CU-CP1 saves the received information. CU-CP1 sends BEARER CONTEXT MODIFICATION REQUEST to CU-UP1, and the message includes the above information.

In this way, according to the received information, Access Node 1 knows that the Access Node 2 does not accept data forwarded in advance, or accepts the data forwarded in advance, but the data that can be cached is limited by the maximum acceptable amount of the data forwarded in advance that needs to be cached.

According to the received information, Access Node 1 can judge whether it is appropriate to forward data to Access Node 2 in advance, or how much data is forward in advance at most, so as to avoid the overload problem caused by the overload of Access Node 2.

Step 1207: CU-CP1 sends an RRC message RRCReconfiguration, and the message may include information related to the unlicensed spectrum corresponding to the candidate target cell, for example, in the existing information ConditionalReconfiguration.

The unlicensed spectrum related information includes at least one of the following information:
Load information of the unlicensed spectrum;
Measurement configuration of the unlicensed spectrum.

The measurement configuration of the unlicensed spectrum includes at least one of the following information:
A threshold of the RSSI;
A threshold of the CO;
A threshold of the number of LBT failures;
A threshold of the success ratio (percentage) or failure ratio (percentage) of LBT;
A threshold of the average sending duration after LBT success;
An ED threshold;
A maximum ED threshold;
An ED threshold offset;
A flag indicating whether there is another access technology that uses the same spectrum resource.

After receiving the information, the UE can judge the load situation of the unlicensed spectrum of the cell according to the load information of the unlicensed spectrum, for example, to select a cell with lighter load in the unlicensed spectrum, which may be a suitable target cell, among all candidate target cells. The threshold related information refers to the threshold of the result measured and obtained by the UE in the unlicensed spectrum in the cell, and the threshold can be used by the UE to judge whether the cell is suitable for providing services for the UE.

The UE can select the appropriate cell as the target cell of the CHO according to the above information, for example, select a cell with lighter load in the unlicensed spectrum and suitable for serving the UE among all candidate target cells as the target cell, thus reducing the possibility of LBT failure occurring after the handover and enhancing the user experience.

Steps 1208a-1208b: If the handover belongs to the DAPS handover and the handover is successful, the UE generates a Successful Handover report. The report includes at least one of the following information related to the quality of service:
An interval between the time of the last service data packet (for example, SDAP data packet) received on the connection of the source access node and the time of the first service data packet received on the connection of the target access node;
A number of lost packets and/or a ratio of lost packets of service data packets in a period;
An average delay of service data packets in a period;
An average jitter of service data packets in a period;
A Starting time, and/or an ending time, and/or a length of time of the period.

According to the existing mechanism, the report is sent to Access Node 1.

Step 1209: If the handover belongs to the DAPS handover, but the handover fails, the UE reconnects to Access Node 1, and the UE generates failure information (FailureInformation). The report includes at least one of the following information related to the quality of service:
An interval between the time of the last service data packet (for example, SDAP data packet) received on the connection of the source access node and the time of the first service data packet received on the connection of the target access node;
A number of lost packets and/or a ratio of lost packets of service data packets in a period;
An average delay of service data packets in a period;
An average jitter of service data packets in a period;
A starting time, and/or an ending time, and/or a length of time of the period.

According to the existing mechanism, the report is sent to Access Node 1.

According to the above information, the access node can judge the degree that the data transmitted by the UE is affected in the procedure of DAPS handover, such as the time when the service is interrupted and whether operation of the service is stable. If the data transmitted by UE is greatly affected, for example, the time when the service is interrupted is too long or operation of the service is extremely unstable, Access Node 1 can make self-configuration and self-optimization, for example, modifying the strategy of DAPS handover, and then selecting a more suitable target cell under similar circumstances, thus ensuring that the transmission of data by the UE is less affected in the handover procedure, and finally improving the user experience.

### Embodiment 11

Embodiment 11 describes a situation where a dual-connectivity is configured for a UE in a scenario of unlicensed spectrum deployment in a 5G network.

FIG. 13 is a schematic diagram of embodiment 11, which includes the following steps.

Step 1301: A source SN may select a target SN, for example, according to the measurement report of the UE. As described in step 901, the source SN sends a RESOURCE STATUS REQUEST message to MN. The message carries a piece of request information, which requests MN to report the load information of unlicensed spectrums of one or more cells. The cell belongs to the target SN.

Steps 1302-1303: MN sends RESOURCE STATUS REQUEST to the target SN as in step 901. The target SN sends RESOURCE STATUS RESPONSE to MN as in step 904. They will not be repeated here for avoiding redundancy.

Step 1304: MN sends RESOURCE STATUS RESPONSE to the source SN.

Step 1305: The target SN sends a RESOURCE STATUS UPDATE message to MN as in step 905, and the message includes the requested load information of the unlicensed spectrum.

Step 1306: MN sends a RESOURCE STATUS UPDATE message to the source SN, and the message includes the requested load information of the unlicensed spectrum.

The source SN may judge whether the target SN is a suitable target SN according to the received information. For example, the source SN can judge whether the target SN is suitable for operating in the unlicensed spectrum according to the information received in the previous step, and can judge whether the UE is suitable for operating in the unlicensed spectrum according to the received measurement report of the UE as described in step 601, and can also judge whether the target SN is suitable for serving as the UE's SN in the unlicensed spectrum in combination with the above information and according to signal quality related parameters of a cell on the target SN reported by the UE.

Step 1307: The source SN initiates the SN change procedure and sends S-NODE CHANGE REQUIRED to MN. The message may include a piece of measurement report information, which may include the result of the measurement by the UE on the channel of the cell to which the target node belongs. The measurement report information includes the information as described in step 601. This can be achieved by two methods.

Method 1: The measurement report information is included in the information “SNG-RAN node to M-NG-RAN node Container” included in S-NODE CHANGE REQUIRED, and the information is a piece of container information. The container information includes RRC information CG-Config, and the RRC information may include measurement result information, which may be MeasResult2NR and/or MeasResultNR, and may include the measurement report information.

Method 2: The measurement report information is included by the message instead of being included by a piece of container information.

Steps 1301-1307 can be used in a scenario where SN initiates the SN change.

Step 1308: MN sends S-NODE ADDITION REQUEST to the target SN. The message may include a piece of measurement report information, which may include the result of the measurement by UE on the channel of the cell to which the target node belongs. The measurement report information includes the information as described in step 601. This can be achieved by two methods.

Method 1: The measurement report information is included in the information “MNG-RAN node to S-NG-RAN node Container” included in the message, and the information is a piece of container information. The container information includes RRC information CG-ConfigInfo, and the RRC information may include measurement result information, which may be MeasResult2NR and/or MeasResultNR, and may include the measurement report information.

Method 2: The measurement report information is included by message instead of being included by a piece of container information.

In this way, the target SN obtains the measurement report information, which may include the result of the measurement by the UE on the channel of the cell to which the target node belongs.

The target SN can select a suitable PSCell for the UE according to the received information. For example, the target SN can judge whether the cell to which it belongs is suitable for operating in the unlicensed spectrum according to its own measurement results in the used unlicensed spectrum, can judge whether the UE is suitable for operating in the unlicensed spectrum according to the received measurement report information, and can also judge whether the cell is suitable for being configured as a PSCell of the UE in combination with the above information and according to the signal quality related parameters of the cell reported by the UE.

According to the above procedure, the target SN can select an appropriate PSCell, which reduces the possibility of failure, such as a LBT failure, and enhances the user experience.

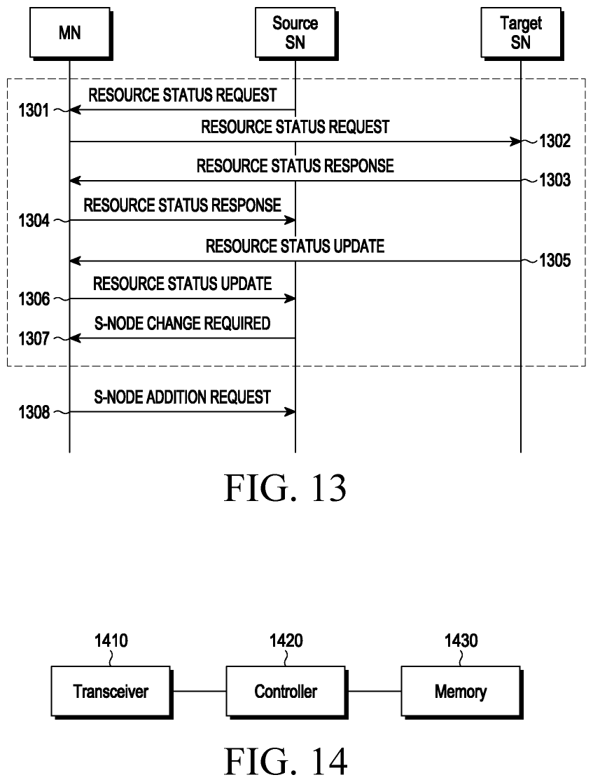

FIG. 14 is a block diagram of a node device in a network according to the present disclosure.

Node devices in the network can be used to implement DU, CU-UP, CU-CP, gNB, eNB, source base station, destination base station, source DU, source CU-UP, source CU-CP, destination DU, destination CU-UP, destination CU-CP, etc. of the present disclosure. Referring to FIG. 10, the network device according to the present disclosure includes a transceiver 1410, a controller 1420 and a memory 1430. The transceiver 1410, the controller 1420, and the memory 1430 are configured to perform the operations of embodiments 1 to 11 of the present disclosure. Although the transceiver 1410, the controller 1420 and the memory 1430 are shown as separate entities, they may be implemented as a single entity, such as a single chip. The transceiver 1410, the controller 1420, and the memory 1430 may be electrically connected or coupled to each other. The transceiver 1410 can send signals to other network devices and receive signals from other network entities, and other network node devices are for example UE, base station or core network node. The controller 1420 may include one or more processing units, and may control network devices to perform operations and/or functions according to one of the above embodiments. The memory 1430 may store instructions for implementing operations and/or functions of one of the above embodiments.

1. A method performed by a first node in a wireless communication network, the method comprising:
receiving, from a second node, a first message related to node configuration, the first message including first configuration information about at least one served cell of the first node; and
transmitting, to the second node, a second message in response to the first message,
wherein the first configuration information includes second configuration information about at least one unlicensed channel.

2. The method of claim 1, wherein the second configuration information includes at least one of:
a channel identifier (ID) of the at least one unlicensed channel,
a center frequency of a bandwidth of the at least one unlicensed channel, or
the bandwidth of the at least one unlicensed channel.

3. The method of claim 1, further comprising:
receiving, from the second node, a third message to request for reporting load measurement,
wherein the third message includes third configuration information about a measurement object that the second node is requested to report, and
wherein the measurement object includes at least one unlicensed channel.

4-5. (canceled)

6. The method of claim 3, further comprising:
transmitting, to the second node, a fourth message for a report of the load measurement in response to the third message;
wherein the fourth message for the report of the load measurement includes at least one of:
a channel identifier (ID) of the at least one unlicensed channel,
a channel occupancy ratio/percentage (CO) in the random access, and
an energy detection threshold used for downlink (DL) channel.

7-8. (canceled)

9. The method of claim 1, wherein an interface between the first node and the second node is an Xn interface, or an F1 interface, and
wherein the first message comprises at least one of an Xn setup request, new generation-radio access network (NG-RAN) node configuration update, F1 setup request, or gnodeB-distributed unit (gNB-DU) configuration update.

10-11. (canceled)

12. A method performed by a second node in a wireless communication network, comprising:
transmitting, to the first node, a first message related to node configuration, the first message including first configuration information about at least one served cell of the first node; and
receiving, from the second node, a second message in response to the first message,
wherein the first configuration information includes second configuration information about at least one unlicensed channel.

13. (canceled)

14. A first node in a wireless communication network, the first node comprising:
a transceiver, configured to receive and send signals; and
at least one processor, coupled with the transceiver and configured to:
receive, from a second node, a first message related to node configuration, the first message including first configuration information about at least one served cell of the first node, and
transmit, to the second node, a second message in response to the first message,
wherein the first configuration information includes second configuration information about at least one unlicensed channel.

15. A second node in a wireless communication network, the second node comprising:
a transceiver, configured to receive and send signals; and
at least one processor, coupled with the transceiver and configured to:
transmit, to the first node, a first message related to node configuration, the first message including first configuration information about at least one served cell of the first node; and
receive, from the second node, a second message in response to the first message,
wherein the first configuration information includes second configuration information about at least one unlicensed channel.

16. The method of claim 12, wherein the second configuration information comprises at least one of:
a channel identifier (ID) of the at least one unlicensed channel,
a center frequency of a bandwidth of the at least one unlicensed channel, or
the bandwidth of the at least one unlicensed channel.

17. The method of claim 12, further comprising:
transmitting, to the first node, a third message to request for reporting load measurement,
wherein the third message includes third configuration information about a measurement object that the second node is requested to report, and
wherein the measurement object includes at least one unlicensed channel.

18. The method of claim 17, further comprising:
receiving, from the first node, a fourth message for a report of the load measurement in response to the third message,
wherein the fourth message for the report of the load measurement includes at least one of:
a channel identifier (ID) of the at least one unlicensed channel,
a channel occupancy ratio/percentage (CO) in the random access, or
an energy detection threshold used for downlink (DL) channel.

19. The method of claim 12, wherein an interface between the first node and the second node is an Xn interface, or an F1 interface, and
wherein the first message comprises at least one of an Xn setup request, new generation-radio access network (NG-RAN) node configuration update, F1 setup request, or gnodeB-distributed unit (gNB-DU) configuration update.

20. The first node of claim 14, wherein the second configuration information comprises at least one of:
a channel identifier (ID) of the at least one unlicensed channel,
a center frequency of a bandwidth of the at least one unlicensed channel, or
the bandwidth of the at least one unlicensed channel.

21. The first node of claim 14, wherein the at least one processor is further configured to:
receive, from the second node, a third message to request for reporting load measurement,
wherein the third message includes third configuration information about a measurement object that the second node is requested to report, and
wherein the measurement object includes at least one unlicensed channel.

22. The first node of claim 21, wherein the at least one processor is further configured to:
transmit, to the second node, a fourth message for a report of the load measurement in response to the third message,
wherein the fourth message for the report of the load measurement includes at least one of:
a channel identifier (ID) of the at least one unlicensed channel,
a channel occupancy ratio/percentage (CO) in the random access, or
an energy detection threshold used for downlink (DL) channel.

23. The first node of claim 14, wherein an interface between the first node and the second node is an Xn interface, or an F1 interface, and
wherein the first message comprises at least one of an Xn setup request, new generation-radio access network (NG-RAN) node configuration update, F1 setup request, or gnodeB-distributed unit (gNB-DU) configuration update.

24. The second node of claim 15,
wherein the second configuration information comprises at least one of:
a channel identifier (ID) of the at least one unlicensed channel,
a center frequency of a bandwidth of the at least one unlicensed channel, or
the bandwidth of the at least one unlicensed channel.

25. The second node of claim 15, wherein the at least one processor is further configured to:
transmit, to the first node, a third message to request for reporting load measurement,
wherein the third message includes third configuration information about a measurement object that the second node is requested to report, and
wherein the measurement object includes at least one unlicensed channel.

26. The second node of claim 25, wherein the at least one processor is further configured to:
receive, from the first node, a fourth message for a report of the load measurement in response to the third message, and
wherein the fourth message for the report of the load measurement includes at least one of:
a channel identifier (ID) of the at least one unlicensed channel,
a channel occupancy ratio/percentage (CO) in the random access, or
an energy detection threshold used for downlink (DL) channel.

27. The second node of claim 15, wherein an interface between the first node and the second node is an Xn interface, or an F1 interface, and
wherein the first message comprises at least one of an Xn setup request, new generation-radio access network (NG-RAN) node configuration update, F1 setup request, or gnodeB-distributed unit (gNB-DU) configuration update.
